(19) United States
(12) Patent Application Publication
(10) Pub. No.: US 2015/0130921 A1
(43) Pub. Date: May 14, 2015

(54) IMAGE PROCESSING APPARATUS AND IMAGE PROCESSING METHOD

(71) Applicant: SONY CORPORATION, TOKYO (JP)

(72) Inventors: TAKESHI OHASHI, KANAGAWA (JP); TAKUYA NARIHIRA, TOKYO (JP)

(21) Appl. No.: 14/525,693

(22) Filed: Oct. 28, 2014

(30) Foreign Application Priority Data
Nov. 11, 2013 (JP) 2013-233436

(51) Int. Cl. G02B 21/36

(52) U.S. Cl. CPC G02B 21/367; G02B 21/368
USPC 348/79

(57) ABSTRACT

An image processing apparatus includes an image acquisition unit, a visual field information generation unit, and a display controller. The image acquisition unit is configured to acquire an input image having a first resolution, the input image being generated by capturing an observation image of an observation target of a user. The visual field information generation unit is configured to compare a specimen image with the input image, the specimen image including an image of the observation target and having a second resolution that is higher than the first resolution, to generate visual field information for identifying a visual field range corresponding to the input image in the specimen image. The display controller is configured to acquire information corresponding to the visual field range in the specimen image, based on the visual field information, and output a signal for displaying the information.

### CROSS REFERENCE TO RELATED APPLICATIONS

This application claims the benefit of Japanese Priority Patent Application JP 2013-233436 filed Nov. 11, 2013, the entire contents of which are incorporated herein by reference.

### BACKGROUND

The present disclosure relates to an image processing apparatus and an image processing method that serve for image processing of pathological images or the like. In the past, medical doctors and the like who perform pathological diagnoses have performed pathological diagnoses by observing slides of pathological tissue specimens or the like with use of a microscope apparatus. The medical doctors and the like are used to an observation with the microscope apparatus and can smoothly perform operations, diagnoses, and the like on slide specimens.

Meanwhile, a microscope image obtained by directly capturing an observation image with use of a microscope has a low resolution and has a difficulty in serving for image processing such as image recognition with a similar sample. Further, in general, the microscope image can provide only image information, and thus there arises a problem in diagnostic efficiency, such as a necessity of referring to patient information included in a medical record as appropriate.

In this regard, recently, virtual slides obtained by digitizing pathological tissue specimens or the like have been used. The virtual slides can be stored in association with not only information obtained from pathological images or the like on the pathological tissue specimens but also additional information (annotation) such as past medical histories of patients. Further, the virtual slide has a higher resolution than that of an image captured with a microscope apparatus or the like. This can facilitate the image processing. Thus, the virtual slides are used as a useful tool in a pathological diagnosis and the like, in combination with an observation with use of a microscope.

For example, Japanese Patent Application Laid-open Nos. 2013-72994 and 2013-72995 each disclose a technique of moving a stage of a microscope, on which a slide of pathological tissue specimens is placed, by an operation using a touch panel on a virtual slide, thus manipulating an observation position of the slide.

### SUMMARY

However, there is a problem that the medical doctors and the like who are used to an observation with use of a microscope have a difficulty in operating a virtual slide and failing to smoothly perform an operation such as displaying a desired area. In view of the circumstances as described above, it is desirable to provide an image processing apparatus and an image processing method that are capable of enhancing the operability of a digitized specimen image.

According to an embodiment of the present disclosure, there is provided an image processing apparatus including an image acquisition unit, a visual field information generation unit, and a display controller. The image acquisition unit is configured to acquire an input image having a first resolution, the input image being generated by capturing an observation image of an observation target of a user.

The visual field information generation unit is configured to compare a specimen image with the input image, the specimen image including an image of the observation target and having a second resolution that is higher than the first resolution, to generate visual field information for identifying a visual field range corresponding to the input image in the specimen image. The display controller is configured to acquire information corresponding to the visual field range in the specimen image, based on the visual field information, and output a signal for displaying the information.

According to the image processing apparatus, an image corresponding to the visual field range in the virtual slide, which corresponds to the observation image of the observation target that the user is observing, the annotation information, and the like can be output. This allows the image corresponding to a microscope image in the virtual slide or the annotation information to be acquired by an operation on the microscope apparatus side. So, it is possible to enjoy convenience of the virtual slide while using operability of the microscope apparatus that is easy to handle by a medical doctor and the like.

The visual field information generation unit may be configured to acquire information on a magnifying power of the observation image and compare the specimen image with the input image by using a ratio of a magnifying power of the specimen image to the magnifying power of the observation image. In general, the magnifying power of the observation image in the microscope apparatus may take a predetermined value that is unique to an objective lens or the like. So, a ratio of the magnifying power of the observation image to the magnifying power of the virtual slide is used for comparison, and thus a load of comparison processing can be reduced.

The visual field information generation unit may be configured to instruct, when failing to generate the visual field information, a user to capture another observation image of the observation target. Thus, even when image comparison fails, it is possible to acquire an input image having a characteristic part as an image, and to lead to a success in comparison.

The visual field information generation unit may be configured to determine, when failing to generate the visual field information, whether the magnifying power of the observation image is a predetermined magnifying power or lower, and instruct, when the magnifying power of the observation image is not the predetermined magnifying power or lower, the user to capture an observation image with the predetermined magnifying power or lower.

Thus, it is possible to acquire an input image having a low magnifying power, from which a more characteristic part is easy to extract. The visual field information generation unit may be configured to instruct, when failing to generate the visual field information, the user to capture another observation image that is different from the observation image in position on the observation target.

Thus, when the comparison fails, it is possible to move the observation target and acquire an input image having a more characteristic part. The visual field information generation unit may be configured to acquire, when generating the visual field information, annotation information attached to an area corresponding to the visual field range of the specimen image.

Thus, in a pathological diagnosis, annotation information such as medical record information attached to the specimen image can be used. So, based on an operation of the microscope apparatus, it is possible to use an abundance of information attached to the specimen image and increase an efficiency of the pathological diagnosis.

The image acquisition unit may be configured to acquire identification information of the observation target together with the input image, and the visual field information generation unit may be configured to identify an image area corresponding to the observation target in the specimen image based on the identification information and compare the image area with the input image.

Thus, a comparison range of the specimen image can be limited. So, a load of processing in the image comparison can be reduced. The visual field information generation unit may be configured to compare the specimen image with the input image, based on a plurality of scale invariant feature transform (SIFT) feature amounts extracted from the specimen image and a plurality of SIFT feature amounts extracted from the input image.

Thus, even in the case where a corresponding visual field range in the specimen image is rotated with respect to the input image or its scale is different from that of the input image, it is possible to perform highly accurate image comparison.

According to another embodiment of the present disclosure, there is provided an image processing method including: acquiring an input image having a first resolution, the input image being generated by capturing an observation image of an observation target; comparing a specimen image with the input image, the specimen image including an image of the observation target and having a second resolution that is higher than the first resolution; generating visual field information for identifying a visual field range corresponding to the input image in the specimen, based on a result of the comparison; and acquiring information corresponding to the visual field range in the specimen image, based on the visual field information, and outputting a signal for displaying the information.

As described above, according to the present disclosure, there is provided an image processing apparatus and an image processing method that are capable of enhancing the operability of a digitized specimen image. It should be noted that the effects disclosed herein are not necessarily limited and may be any of the effects disclosed herein. These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram of an image processing system including an image processing apparatus according to a first embodiment of the present disclosure;

FIG. 2 is a block diagram of the image processing system;

FIG. 3 is a flowchart showing an operation example of a visual field information generation unit of the image processing apparatus;

FIG. 4A is a schematic diagram of an input image in which a plurality of second feature points are extracted;

FIG. 4B is a schematic diagram for describing a relationship between a SIFT (Scale Invariant Feature Transform) feature amount of a second feature point having a code book number 6 shown in FIG. 4A and a reference point and visual field vector of the input image;

FIG. 5 is a schematic diagram showing a result of a vote performed on each first feature point of a virtual slide;

FIGS. 6A and 6B are diagrams for describing actions and effects of an image processing apparatus according to a modified example of the first embodiment, FIG. 6A showing an example of information obtained by using only a microscope apparatus, FIG. 6B showing an example of information obtained by using the image processing apparatus;

FIG. 7 is a block diagram of an image processing system including an image processing apparatus according to a second embodiment of the present disclosure;

FIG. 8 is a schematic diagram showing a result of a vote performed on each first feature point of the virtual slide and corresponds to FIG. 5;

FIG. 9 is a block diagram of an image processing system including an image processing apparatus according to a third embodiment of the present disclosure;

FIG. 10 is a flowchart showing an operation example of the visual field information generation unit of the image processing apparatus;

FIG. 11 is a diagram showing an example in which an instruction from an image acquisition instruction unit of the image processing apparatus is displayed on a display;

FIG. 12 is a diagram showing an example in which an instruction from the image acquisition instruction unit of the image processing apparatus is displayed on the display;

FIG. 13 is a block diagram of an image processing system including an image processing apparatus according to a modified example of the third embodiment of the present disclosure;

FIG. 14 is a flowchart showing an operation example of a visual field information generation unit of the image processing apparatus according to the modified example;

FIG. 15 is a block diagram of an image processing system including an image processing apparatus according to a fourth embodiment of the present disclosure;

FIG. 16 is a schematic diagram of an image processing system including an image processing apparatus according to a fifth embodiment of the present disclosure; and

FIG. 17 is a block diagram of the image processing system.

### DETAILED DESCRIPTION OF EMBODIMENTS

Hereinafter, embodiments of the present disclosure will be described with reference to the drawings.

### First Embodiment

### Image Processing System

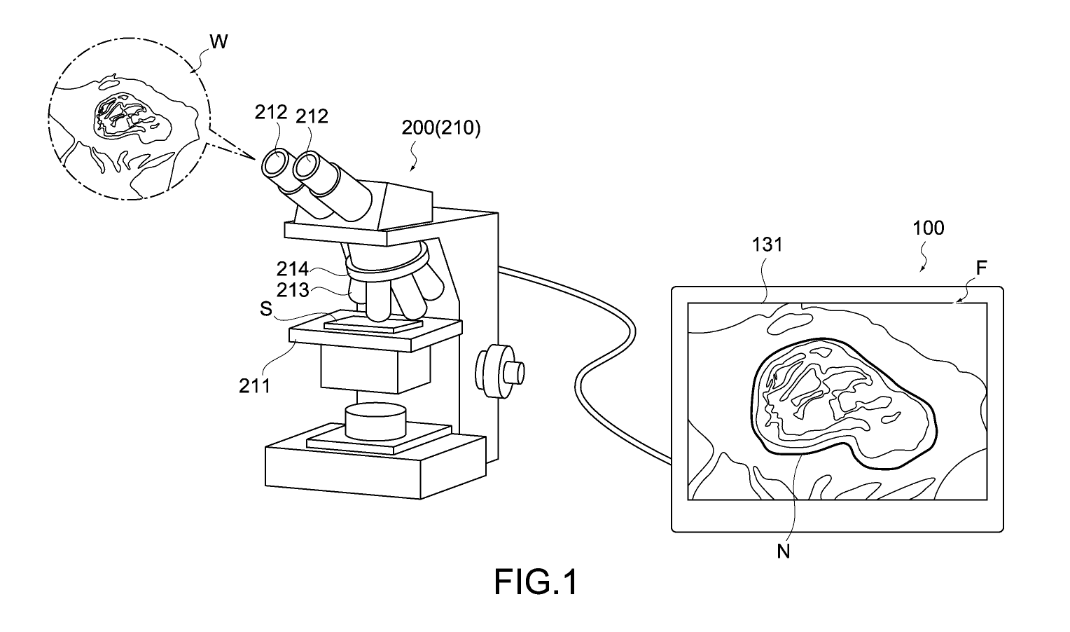

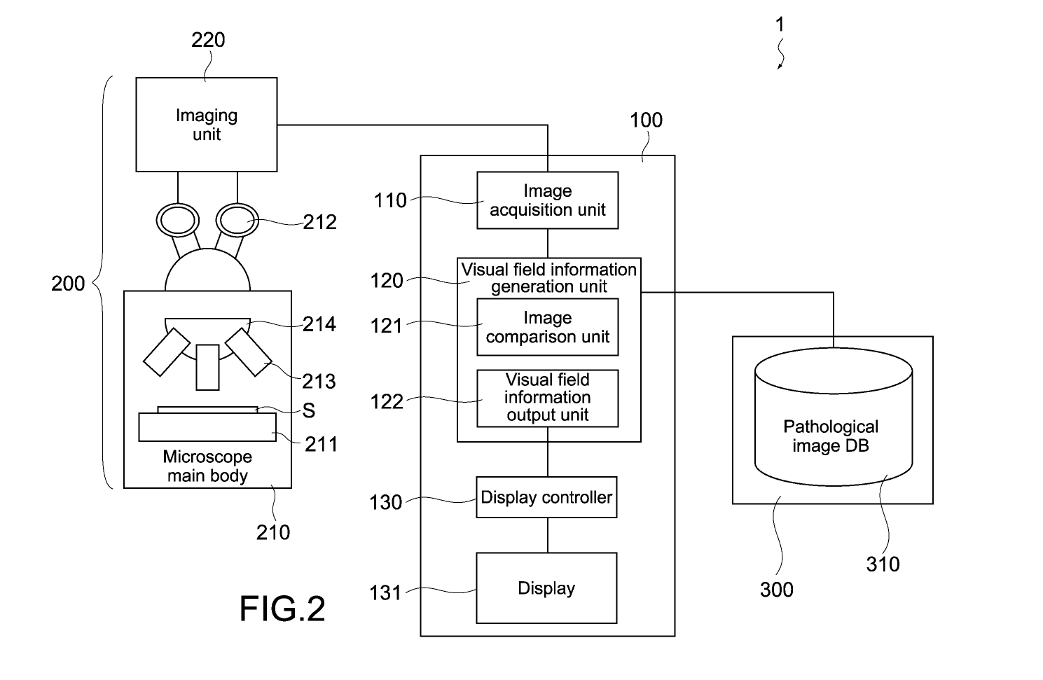

FIG. 1 is a schematic diagram of an image processing system 1 according to a first embodiment of the present disclosure, and FIG. 2 is a block diagram of the image processing system 1. The image processing system 1 includes an image processing apparatus 100, a microscope apparatus 200, and a server apparatus 300 including a pathological image database (DB) 310 in which a specimen image (virtual slide) is stored (see FIG. 2). The microscope apparatus 200 and the server apparatus 300 are connected to the image processing apparatus 100.

As shown in FIG. 1, the image processing system 1 is configured to cause the image processing apparatus 100 to display an image (output image F) of a virtual slide with the same visual field range as that of an observation image W, which is observed with the microscope apparatus 200. For example, the image processing system 1 can be used for what is called pathological diagnosis in which a user such as a medical doctor observes a slide specimen S including a pathological tissue slice with use of the microscope apparatus 200 and performs a diagnosis based on information obtained from the slide specimen S.

(Microscope Apparatus)

The microscope apparatus 200 includes a microscope main body 210 and an imaging unit 220 (see FIG. 2) and captures an observation image W of an observation target to acquire an input image. As the observation target, for example, a slide specimen S is used. The slide specimen S is formed of a pathological tissue slice that has been subjected to HE (Haematoxylin Eosin) dying or the like and attached to a glass slide.

The microscope main body 210 is not particularly limited as long as the slide specimen or the like can be observed in a bright field at a predetermined magnifying power. For example, various microscopes such as an erecting microscope, a polarizing microscope, and an inverted microscope may be applicable. The microscope main body 210 includes a stage 211, an eyepiece lens 212, a plurality of objective lenses 213, and an objective lens holding unit 214. Typically, the eyepiece lens 212 includes two (binocular) eyepiece lenses corresponding to a right eye and a left eye and has a predetermined magnifying power. The user looks into the eyepiece lens 212 and thus observes the slide specimen S.

The stage 211 is configured so as to be capable of placing a slide specimen or the like thereon and to be movable in a plane parallel to a surface on which the slide specimen or the like is placed (hereinafter, the surface being referred to as a placing surface) and in a direction perpendicular to the placing surface. The user such as a medical doctor moves the stage 211 in the plane parallel to the placing surface, and thus the visual field in the slide specimen S can be moved and a desired observation image can be acquired via the eyepiece lens 212. Further, the stage 211 is moved in the direction perpendicular to the placing surface, and thus an in-focus state can be obtained in accordance with the magnifying power.

The objective lens holding unit 214 holds the plurality of objective lenses 213 and configured to be capable of switching the objective lens 213 disposed on an optical path. Specifically, a revolver or the like that can mount the plurality of objective lenses 213 is applicable to the objective lens holding unit 214. Further, in a method of switching between the plurality of objective lenses 213, the objective lens holding unit 214 may be driven manually or automatically based on an operation of the user, or the like. In general, the plurality of objective lenses 213 each have a unique magnifying power. For example, the objective lenses 213 having the magnifying powers of 1.25×, 2.5×, 5×, 10×, 40×, and the like are applied.

The imaging unit 220 is connected to the microscope main body 210 and configured to be capable of capturing an observation image W acquired by the microscope main body 210 and generating an input image. A specific configuration of the imaging unit 220 is not particularly limited. For example, a configuration including an imaging device such as a CCD (Charge-Coupled Device) image sensor or a CMOS (Complementary Metal-Oxide Semiconductor) image sensor can be provided. Here, the “observation image” refers to the visual field in the slide specimen S, the visual field being observed by the user using the microscope apparatus 200. Typically, the input image is generated by capturing an image of a part of the observation image W.

The microscope apparatus 200 is configured to be capable of outputting the input image, which is generated by the imaging unit 220, to the image processing apparatus 100. The communication method therefor is not particularly limited and may be wired communication via a cable or the like or wireless communication.

(Server Apparatus)

The server apparatus 300 is configured to be capable of providing the pathological image DB 310 to the image processing apparatus 100. In other words, the server apparatus 300 may include a memory that stores the pathological image DB 310, a CPU (Central Processing Unit), a ROM (Read Only Memory), a RAM (Random Access Memory), and the like. The memory can be constituted of, for example, an HDD (Hard Disk Drive) and a non-volatile memory such as a flash memory (SSD; Solid State Drive). Those memory, CPU, ROM, and RAM are not illustrated.

The pathological image DB 310 includes a virtual slide. The virtual slide is obtained by digitizing the entire slide specimen of each of a plurality of slide specimens, which include the slide specimen serving as the observation target, with use of a dedicated virtual slide scanner or the like. For example, the pathological image DB 310 may include virtual slides corresponding to several thousands to several tens of thousands of slide specimens, for example. It should be noted that when the “virtual slide” is simply referred to in the following description, the “virtual slide” refers to digital images of a plurality of slide specimens. The virtual slide has a second resolution higher than a first resolution and is an image having a higher resolution than the input image. Further, the virtual slide may include a plurality of layer images with different focuses.

In the virtual slide, annotation information (attached information) such as identification numbers of the plurality of respective slide specimens and patient information (age, gender, medical history, etc.) included in an electronic medical record are each associated with a corresponding image area. Alternatively, a mark N of a portion that is determined to be a tumor for example, as shown in the output image F of FIG. 1, is also included as the annotation information. In such a manner, according to the virtual slide, a determination, a memo, and the like of the medical doctor as the user can be stored as the annotation information together with images. Those pieces of annotation information may be stored in the memory of the server apparatus 300, another server apparatus connected to the server apparatus 300, or the like.

The communication method between the server apparatus 300 and the image processing apparatus 100 is not particularly limited, and for example, communication via a network may be performed. The image processing apparatus 100 is configured to be capable of comparing the input image, which is captured with the microscope apparatus 200, with a virtual slide in the server apparatus 300, to display an image corresponding to the input image in the virtual slide, annotation information attached to the image, and the like. Hereinafter, the configuration of the image processing apparatus 100 will be described.

[Image Processing Apparatus]

The image processing apparatus 100 includes an image acquisition unit 110, a visual field information generation unit 120, a display controller 130, and a display 131. For example, the image processing apparatus 100 may be constituted as an information processing apparatus such as a PC (Personal Computer) or a tablet terminal.

(Image Acquisition Unit)

The image acquisition unit 110 acquires an input image having a first resolution. The input image is generated by capturing an observation image of an observation target. The image acquisition unit 110 is connected to the microscope apparatus 200 and is constituted as an interface that communicates with the microscope apparatus 200 according to a predetermined standard. The image acquisition unit 110 outputs the acquired input image to the visual field information generation unit 120.

(Visual Field Information Generation Unit)

The visual field information generation unit 120 compares a virtual slide with the input image, the virtual slide including an image of the observation target and having a second resolution higher than the first resolution, to generate visual field information for identifying a visual field range corresponding to the input image in the virtual slide. The visual field information generation unit 120 is constituted of a CPU, for example. The visual field information generation unit 120 can execute processing according to a program stored in a memory (not shown) or the like. The visual field information generation unit 120 includes an image comparison unit 121 and a visual field information output unit 122.

The image comparison unit 121 compares the virtual slide with the input image. The image comparison unit 121 can transmit a request for necessary processing to the server apparatus 300, for example, and the server apparatus 300 responds to the request. Thus, image comparison processing can be advanced.

In this embodiment, the image comparison unit 121 can compare the virtual slide with the input image based on a plurality of SIFT (Scale Invariant Feature Transform) feature amounts extracted from the virtual slide and on a plurality of SIFT feature amounts extracted from the input image. The SIFT feature amount is a feature amount including 128-dimensional luminance gradient information of pixels around each feature point, and can be represented by parameters such as a scale and a direction (orientation). Even in the case where the input image and the visual field range of the virtual slide have magnifying powers or rotation angles that are different from each other, the comparison can be performed with high accuracy by using the SIFT feature amounts. It should be noted that for the method of comparing those images, another method can be adopted.

The visual field information output unit 122 outputs the visual field information for identifying the visual field range corresponding to the input image, based on a result of the comparison, to the display controller 130.

The visual field information includes a plurality of parameters with which the visual field range corresponding to the input image can be identified, from the virtual slide. Examples of such parameters include an identification number (slide ID) of a slide specimen including that visual field range, coordinates of a center point of that visual field range, the magnitude of the visual field range, and a rotation angle. Further, in the case where the virtual slide includes a plurality of layer images with different focuses, a layer number representing the depth of a focus corresponding to the input image may be added as the parameter of the visual field information.

(Display Controller)

The display controller 130 acquires information corresponding to the visual field range based on the visual field information described above, the visual field range corresponding to the input image in the virtual slide, and outputs a signal for displaying that information. The information may be, for example, an image of an area corresponding to the visual field range of the virtual slide (hereinafter, referred to as an output image) or may be annotation information that is attached to the area corresponding to the visual field range of the virtual slide. Alternatively, the display controller 130 may perform control to display both of the output image and the annotation information, as the above-mentioned information.

(Display)

The display 131 is configured to be capable of displaying the above-mentioned information based on the signal output from the display controller 130. The display 131 is a display device using an LCD (Liquid Crystal Display) or an GELD (Organic ElectroLuminescence Display), for example, and may be configured as a touch panel display.

[Operation of Visual Field Information Generation Unit]

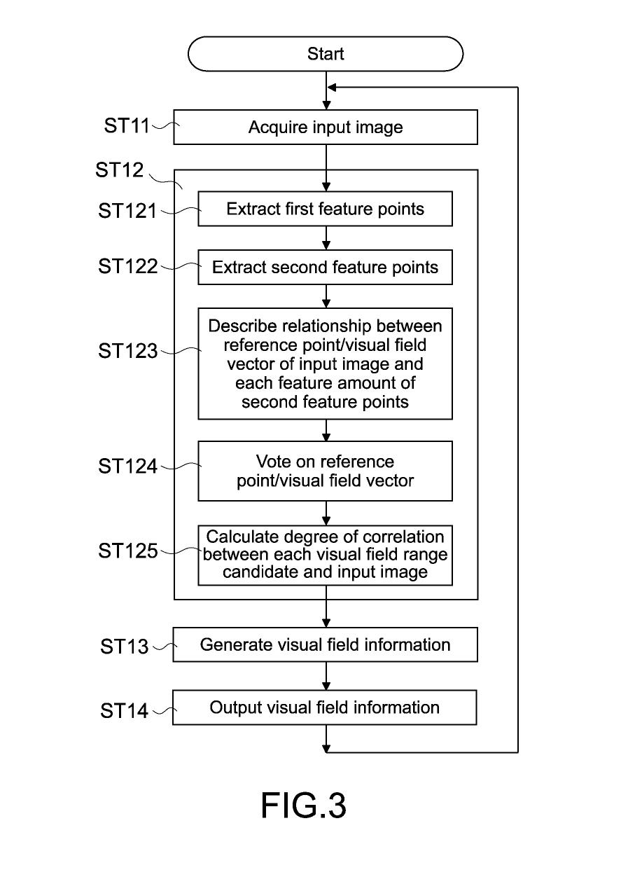

FIG. 3 is a flowchart showing an operation example of the visual field information generation unit 120. The visual field information generation unit 120 acquires an input image from the image acquisition unit 110 (ST11). The input image has a first resolution and is generated by capturing an observation image of a slide specimen.

Next, the image comparison unit 121 of the visual field information generation unit 120 compares a virtual slide with the input image (ST12). In this embodiment, the visual field information generation unit 120 compares the virtual slide with the input image based on a plurality of SIFT feature amounts, which are extracted from the virtual slide, and on a plurality of SIFT feature amounts, which are extracted from the input image. Hereinafter, this step will be described in detail.

First, the image comparison unit 121 extracts, from the virtual slide, a plurality of first feature points each having a unique SIFT feature amount (ST121). Specifically, the image comparison unit 121 performs processing of extracting the SIFT feature amounts on the virtual slide and acquires a large number of SIFT feature amounts. Further, the image comparison unit 121 performs clustering processing such as k-means processing on the SIFT feature amount groups and thus can obtain a plurality of first feature points each serving as a centroid of each cluster. Here, for example, in the case where k=100 in the k-means processing, 100 aggregates (code books) of the first feature points can be obtained.

The processing described above allows an ID (code book number) to be imparted to each first feature point. For example, in the case where k=100 in the k-means processing, code book numbers of 1 to 100 can be imparted. The first feature points with a single code book number are points having substantially the same SIFT feature amount. Further, a plurality of first feature points with a single code book number may exist in the whole of the virtual slides. It should be noted that in the following description, the phrase of “substantially the same SIFT feature amount” means the same SIFT feature amount or SIFT feature amounts that are considered to be the same by being classified into the same cluster by predetermined clustering processing.

Next, the image comparison unit 121 extracts, from the input image, a plurality of second feature points each having a unique SIFT feature amount (ST122). Specifically, the image comparison unit 121 performs processing of extracting the SIFT feature amounts on the input image and acquires a large number of SIFT feature amounts. Further, the image comparison unit 121 assigns a code book number to the points having those SIFT feature amounts, the code book number being the same as that of the first feature points having substantially the same SIFT feature amount, and defines a second feature point associated with any one of the first feature points.

With this operation, a plurality of second feature points to which a code book number of, for example, any one of 1 to 100 is imparted are extracted. It should be noted that the clustering processing such as the k-means processing may be performed as appropriate in this processing as well.

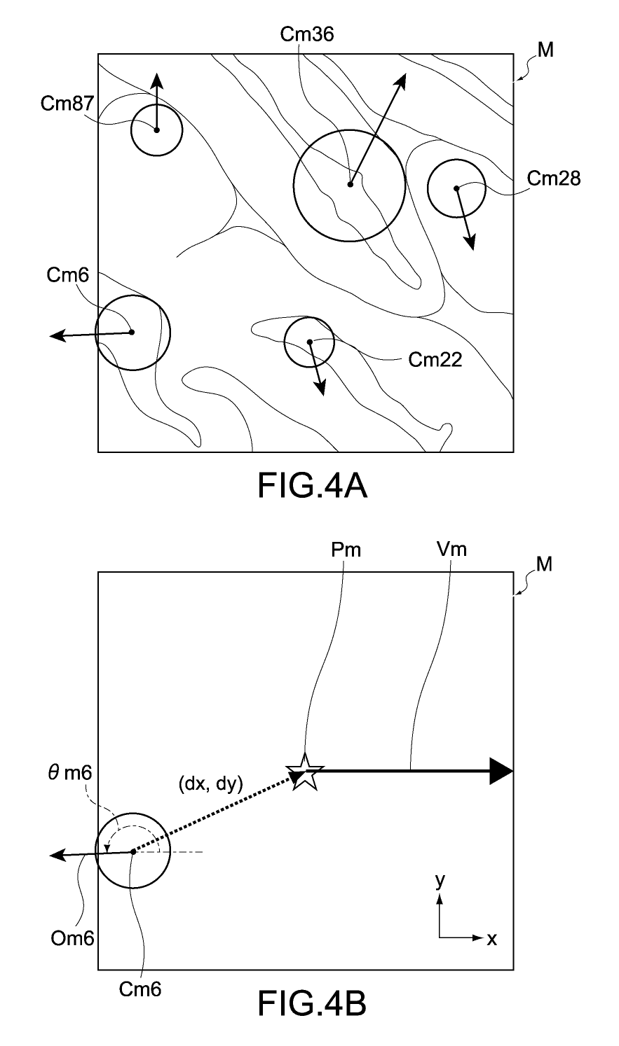

FIG. 4A is a schematic diagram of an input image M in which a plurality of second feature points Cmn are extracted. In FIG. 4A, the scale of each SIFT feature amount is indicated by the size of a circle and the orientation thereof is indicated by a direction of a vector. As shown in FIG. 4A, each second feature point Cmn is expressed as the center of the circle, that is, as a starting point of the vector, and a corresponding code book number n is imparted thereto. In the input image M shown in FIG. 4A, for example, second feature points Cm6, Cm22, Cm28, Cm36, and Cm87 to which code book numbers 6, 22, 28, 36, and 87 are imparted, respectively, are extracted. Each of those second feature points Cmn has a SIFT feature amount, which is substantially the same as that of the first feature point having the same code book number n in the virtual slide.

Next, the image comparison unit 121 describes a relative relationship between a reference point/visual field vector of the input image and each SIFT feature amount of the plurality of second feature points (ST123). The reference point is a point optionally determined in the input image, and the visual field vector is a vector having an optional orientation and size. The reference point/visual field vector of the input image functions as a parameter for defining the visual field range of the input image.

FIG. 4B is a schematic diagram for describing a relationship between the SIFT feature amount of the second feature point Cm6, which has the code book number 6 shown in FIG. 4A, and a reference point Pm and visual field vector Vm of the input image M. In FIG. 4B, the x axis and the y axis are two axes orthogonal to each other. The reference point Pm is a point indicated by a star sign in FIG. 4B and can be assumed to be the center point of the input image M, for example. Further, the visual field vector Vm can be a vector being parallel to an x-axis direction and having a predetermined size, for example.

As shown in FIG. 4B, a position vector directed from the second feature point Cm6 to the reference point Pm is represented by (dx,dy). Further, an orientation Om6 of the second feature point Cm6 has a rotation angle θm6 with the visual field vector Vm as a reference. In such a manner, the reference point and the visual field vector of the input image are defined. Thus, the coordinates of each second feature point within the visual field range of the input image and the rotation angle of the orientation of the SIFT feature amount of each second feature amount can be described. With this operation, it is possible to describe a relative relationship between the SIFT feature amount of each of the plurality of second feature points and the visual field range of the input image.

Next, the image comparison unit 121 performs a vote of the reference point and the visual field vector on the plurality of first feature points corresponding to the plurality of respective second feature points, based on the relationship described above (ST124). The vote of the reference point and the visual field vector refers to processing of calculating coordinates of a reference point candidate Pvn in the virtual slide and a rotation angle of a visual field vector candidate Vvn in the virtual slide, for each first feature point Cvn in this operation example.

The coordinates of the reference point candidate Pvn in the virtual slide, the reference point candidate Pvn corresponding to each first feature point Cvn, are calculated based on a position vector directed to the reference point Pm from the second feature point Cmn, the position vector being calculated in ST123. Similarly, the rotation angle of the visual field vector candidate Vvn in the virtual slide is calculated based on the rotation angle of the orientation Om6 of the second feature point Cm6 with the visual field vector Vm as a reference, the rotation angle being calculated in ST123.

Here, a specific calculation example of the reference point candidate Pvn and the visual field vector candidate Vvn for defining a visual field range candidate Fn will be described. First, as described with reference to FIG. 4B, parameters for the second feature point Cmn of the input image M will be defined as follows.

Magnitude of scale of SIFT feature amount according to second feature point Cmn: σm

Rotation angle of orientation of SIFT feature amount according to second feature point Cmn: θm
Position vector directed from reference point Pm to second feature point Cmn: (dx,dy)

In the same manner, parameters for the first feature point Cvn of the virtual slide V will be defined as follows.

Coordinates of first feature point Cvn in virtual slide V: (Xvn,Yvn)
Magnitude of scale of SIFT feature amount according to first feature point Cvn: σv
Rotation angle of orientation of SIFT feature amount according to second feature point Cmn with visual field vector candidate Vvn as reference: θv

Thus, a magnitude r of the visual field vector candidate Vvn, a rotation angle (rotation angle with x-axis direction as a reference) φ of the visual field vector candidate Vvn, and coordinates (Xn,Yn) of the reference point candidate Pvn in the virtual slide V can be calculated as follows, with the magnitude of the visual field vector Vmn as R.

r=R×(σv/σm) (1)

φ=θv−θm (2)

Xn=Xvn+(dx²+dy²)^{1/2}*(σv/σm)*cos(θ+θm−θv) (3)

Yn=Yvn+(dx²+dy²)^{1/2}*(σv/σm)*sin(θ+θm−θv) (4)

where θ=arctan(dy/dx))

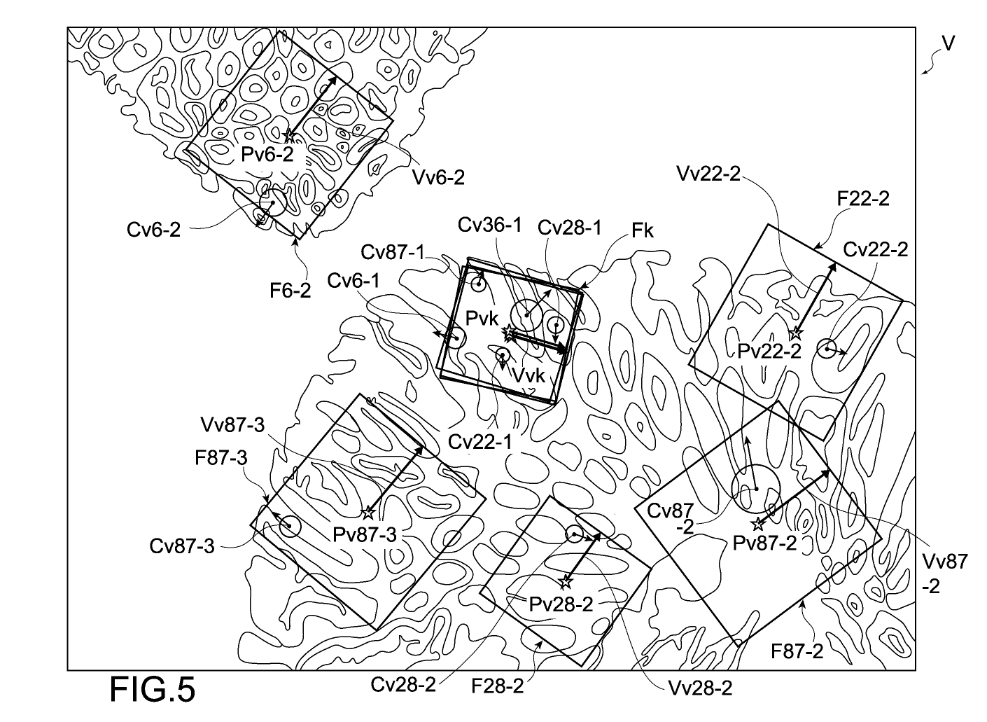

FIG. 5 is a schematic diagram showing a result of a vote performed on each first feature point of the virtual slide. As shown in FIG. 5, the image comparison unit 121 defines the visual field range candidate Fn based on the calculated reference point candidate Pvn and visual field vector candidate Vvn. In FIG. 5, a star sign represents each reference point candidate and a reference symbol Pvn is imparted to the vicinity of the star sign. In the case where there are i feature points having a single code book number, the tail end of a reference symbol is provided with “−i” for distinction.

Here, a visual field range candidate Fk represents a plurality of overlapping visual field range candidates. Specifically, the visual field range candidate Fk represents F6-1, F22-1, F28-1, F36-1, and F87-1. Similarly, a reference point candidate Pvk represents overlapping reference point candidates of Pv6-1, Pv22-1, Pv28-1, Pv36-1, and Pv87-1, and a visual field vector candidate Vvk represents overlapping visual field vector candidates of Vv6-1, Vv22-1, Vv28-1, Vv36-1, and Vv87-1.

The first feature points Cv6-1, Cv22-1, Cv28-1, Cv36-1, and Cv87-1 corresponding to those reference point candidates Pvk and visual field vector candidates Vvk are disposed in a positional relationship similar to that of the second feature points Cm6, Cm22, Cm28, Cm36, and Cm87 of the input image M, respectively. In such a manner, a lot of votes are obtained for the reference point candidates Pvn and the visual field vector candidates Vvn, which correspond to the first feature points Cvn disposed in a positional relationship similar to that of the second feature points Cmn.

In this regard, after the vote is performed on all of the plurality of first feature points, the number of reference point candidates Pvn and visual field vector candidates Vvn having substantially the same coordinates and rotation angle, i.e., the number of votes, are calculated. Thus, the degree of correlation between the input image M and the visual field range candidate Fn corresponding to the reference point candidate Pvn and the visual field vector candidate Vvn can be calculated.

It should be noted that a position (Xn,Yn) of a voted reference point candidate Pvn, an angle φ of the visual field vector candidate Vvn, and the like may be subjected to clustering processing. Through the processing, even when there are some variations in the reference point candidates Pvn and the visual field vector candidates Vvn, a vote for a reference point candidate Pvn located at a closer position and a visual field vector candidate Vvn having a closer angle is considered to be performed for the same reference point and the same visual field vector. Thus, a proper number of votes can be calculated.

Subsequently, the image comparison unit 121 calculates the degree of correlation between each visual field range candidate and the input image based on results of the votes (ST125). The degree of correlation is determined as follows, for example.

(Degree of Correlation)=(Number of Votes)/(Number of Second Feature Points in Input Image) (5)

In the example shown in FIG. 5, the degree of correlation of the visual field range candidate Fk is calculated as 5/5=1, and the degree of correlation of any other visual field range candidate Fn is calculated as ⅕.

As described above, by referring to the degree of correlation between the visual field range candidate of the virtual slide and the input image, the virtual slide and the input image are compared with each other. Subsequently, based on the result of the comparison, the visual field information output unit 122 determines that a visual field range candidate having the largest degree of correlation is a visual field range corresponding to the input image, and generates visual field information for identifying that visual field range (ST13). The visual field information output unit 122 determines that the visual field information related to the visual field range having the largest degree of correlation is a visual field range. In the example shown in FIG. 5, it is assumed that the visual field range candidate Fk is determined as a visual field range.

The visual field information is information including parameters of a slide ID, center coordinates, an angle, a range, and the depth of focus, for example. Those parameters take values corresponding to the following values.

Slide ID: ID of slide specimen including visual field range candidate having the largest degree of correlation

Center Coordinates: position (Xn,Yn) of reference point having the largest degree of correlation
Angle: Angle φ of visual field vector
Range: Magnitude r of visual field vector candidate Vvn
Depth of focus: layer number having the depth of focus corresponding to input image

The visual field information output unit 122 outputs the visual field information to the display controller 130 (ST14). With this operation, the display controller 130 outputs a signal for displaying the output image corresponding to the visual field range in the virtual slide to the display 131 based on the visual field information. Thus, the display 131 displays the output image.

Further, when the user moves the slide specimen serving as the observation target and captures a new observation image, the image acquisition unit 110 acquires a new input image. Subsequently, the visual field information generation unit 120 acquires the input image again (ST11) and repeats the processing described above. With this operation, along with the movement of the visual field range of the input image, the visual field range of the output image displayed on the display 131 can also be moved.

As described above, according to this embodiment, the visual field range in the virtual slide, which corresponds to the observation image of the microscope apparatus 200, can be displayed on the display 131. Thus, the visual field range in the virtual slide can be operated with the microscope apparatus 200. So, it is possible to control the virtual slide while enjoying familiar operability of the microscope apparatus 200 and high visibility by binocular vision. Specifically, according to this embodiment, the following advantages are provided as compared with a diagnosis by an observation using a microscope apparatus 200 in related art.

In a first advantage, the use of a high-resolution image of the virtual slide facilitates image recognition in a diagnosis of tumor or the like and facilitates the use of annotation, for example. So, the first advantage contributes to improvement in efficiency and accuracy of a diagnosis.

In a second advantage, through the observation of a slide specimen or the like with use of the microscope apparatus 200, a virtual slide corresponding to the slide specimen can be displayed immediately. In related art, the microscope and the virtual slide are configured as different systems. Thus, it is necessary to redisplay a visual field range seen through the microscope by using a virtual slide. Thus, it is not said that using an image of the virtual slide while performing an observation with the microscope is efficient. According to this embodiment, it is possible to solve such a problem and contribute to an increase in efficiency of a diagnosis using a virtual slide.

In a third advantage, through the acquisition of the visual field information, a slide ID of the slide specimen being currently observed can be acquired. Thus, it is possible to omit time and effort of inputting the slide ID into an electronic medical record or the like. Further, it is possible to prevent mix-up of the input slide specimen from occurring, an erroneous input of the ID at the input into the electronic medical record from occurring, and the like, and to enhance correctness of a work or a diagnosis. Further, the following advantages are provided as compared with a diagnosis using only a virtual slide.

In a first advantage, in a pathological diagnosis, an abundance of visual information by binocular vision of the microscope can be obtained. In a second advantage, it is possible to create not only a diagnosis log based on a virtual slide but also a diagnosis log based on a microscope and to manage the diagnosis log in association with an area corresponding to the virtual slide. This allows an information analysis using the diagnosis log based on the microscope or a creation of learning materials for medical school students or the like, and thus their quality can be expected to be improved.

Furthermore, the following advantages are provided as compared with the case where an observation image of a microscope is compared with an image captured with the microscope apparatus 200. Specifically, for image recognition processing such as tumor recognition or similar image search, not only a low-resolution image captured with a microscope but also a high-resolution image of a virtual slide can be used. This allows a processing efficiency of the image recognition to be improved and the accuracy of the image recognition to be enhanced. Hereinafter, description will be given on modified examples 1-1 to 1-5 according to this embodiment.

### Modified Example 1-1

The visual field information generation unit 120 may acquire annotation information as well, which is attached to an area corresponding to a visual field range of the virtual slide, when visual field information is generated. As described above, the slide ID and the annotation information such as patient information included in an electronic medical record are stored in the virtual slide in association with the corresponding area. By acquisition of the visual field information, annotation information associated with a visual field range identified by the visual field information can be easily acquired.

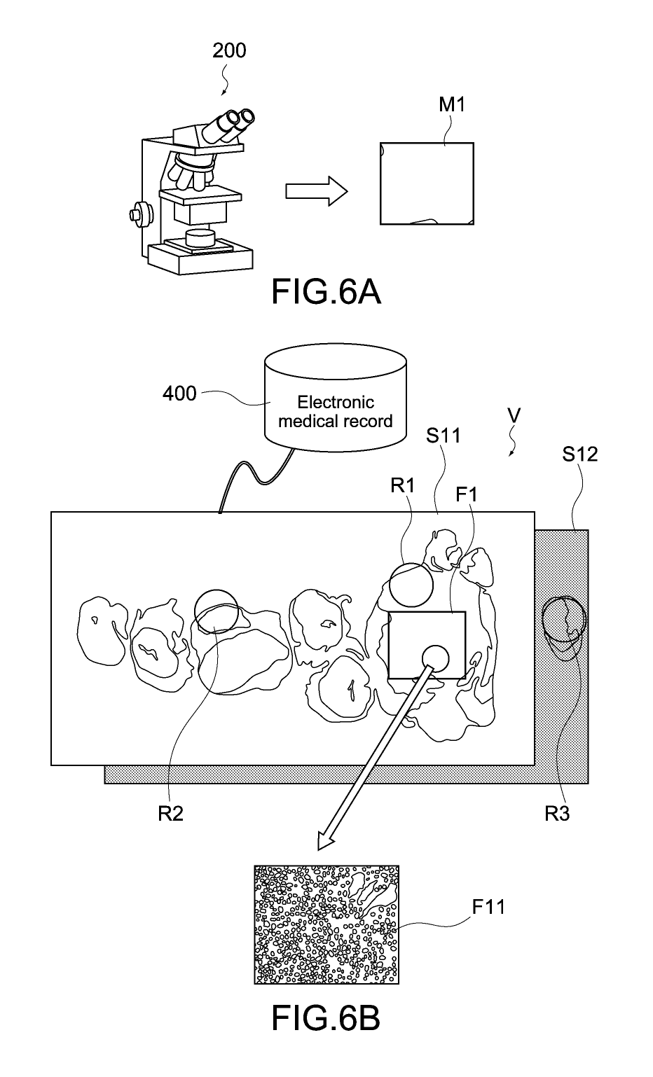

FIGS. 6A and 6B are diagrams for describing actions and effects of the image processing apparatus 100 according to this modified example. FIG. 6A shows an example of information obtained by using only the microscope apparatus 200, and FIG. 6B shows an example of information obtained by using the image processing apparatus 100.

As shown in FIG. 6A, in the case of using only the microscope apparatus 200, only information displayed on an image M1 in a visual field range that the user is observing can be obtained. Further, the image M1 captured with use of the microscope apparatus 200 has a lower resolution than that of a virtual slide V. For that reason, in the case where the image M1 is enlarged to try to check a fine configuration of the nucleus of a cell, for example, the image quality becomes rough and it is difficult to sufficiently observe the image.

On the other hand, as shown in FIG. 6B, by use of the image processing apparatus 100, for example, information of an electronic medical record 400 associated with a slide specimen S11 including a visual field range F1 corresponding to the image M1 can be acquired. Thus, age, gender, a past medical history, and the like of a patient can be acquired together with the image information. So, it is possible to efficiently acquire information necessary for a diagnosis and contribute to an increase in efficiency and speed of a diagnosis.

Specifically, the annotation information may be displayed on the display 131 together with an output image displayed as the visual field range F1. Thus, the annotation information can be checked together with pathological image information. Alternatively, only the annotation information may be displayed on the display 131. Thus, an abundance of information that is attached to the virtual slide V can be easily used by an operation of the microscope apparatus 200.

Further, image information out of the visual field range of the virtual slide is easily acquired. For example, image information of areas R1 and R2 out of the visual field range F1 of the slide specimen S11 and image information of an area R3 in another slide specimen S12 of the same patient can be easily acquired. Thus, an image of the slide specimen S11 including the visual field range F1 and an image of the slide specimen S12 produced prior to the slide specimen S11 are easily compared with each other. This allows a change or progression of a clinical condition to be grasped more adequately.

Furthermore, the virtual slide V has a higher resolution than that of the image M1 captured with use of the microscope apparatus 200. Thus, even in the case where a part of the visual field range F1 is enlarged to be checked, a fine image F11 can be obtained. So, it is possible to easily grasp a detailed condition of a particularly important cell in a pathological examination of tumor, and the like, and to contribute to an increase in efficiency of a diagnosis and an improvement in accuracy of a diagnosis.

### Modified Example 1-2

The visual field information generation unit 120 can compare a partial area of the virtual slide stored in the pathological image DB 310 with the input image. With this configuration, as compared with the case where image comparison is performed on the whole of the virtual slide, the costs for image comparison processing can be largely reduced and processing time can be shortened. Hereinafter, configuration examples 1 to 3 will be described as examples but are not limited as an example of limiting a comparison target, and various configurations may be adopted.

### Configuration Example 1

The visual field information generation unit 120 can compare an area of the virtual slide, the area corresponding to an image of an observation target identified from already-generated visual field information, with the input image. In other words, in the case where first visual field information is generated from a certain input image and subsequently second visual field information is generated from another input image, an area in the virtual slide corresponding to a slide ID obtained based on the first visual field information can be compared with the input image. With this operation, when image comparison processing is successively performed, only an area in the virtual slide corresponding to the same slide specimen can be considered to be a comparison target.

For example, in the case where the image acquisition unit 110 successively acquires input images, it is thought that a slide specimen as an observation target is not replaced in principle. In such a case, the application of this configuration example allows costs for image comparison processing to be largely reduced and processing time to be shortened. Further, when processing according to this configuration example is performed, conditions can be set as appropriate. For example, in the case where the first visual field information is generated and the degree of correlation calculated by Expression (5) has a predetermined threshold or more, this configuration example may be adopted.

### Configuration Example 2

The visual field information generation unit 120 can use only an area, which is created in a predetermined period of time, as a comparison target of the virtual slide. Specifically, a comparison target area can be set by being limited to an area created in the last week or an area created in the last year with a day on which the image processing is performed as a reference. This allows the comparison target area to be largely limited.

### Configuration Example 3

The visual field information generation unit 120 can use only an area corresponding to a slide specimen related to a predetermined medical record number, as a comparison target of the virtual slide. In this case, for example, a user such as a medical doctor may previously input a medical record number or the like of a patient into the image processing apparatus 100. With this operation, an output image or the like of a virtual slide of a patient who is to be diagnosed actually can be displayed rapidly.

### Modified Example 1-3

The display controller 130 may output a signal for displaying an input image captured with use of the microscope apparatus 200, together with an output image related to a virtual slide and annotation information. Thus, a microscope image (input image) and an image of a virtual slide related to the same visual field range, and the like can be displayed on the display 131, and those images can be referred to at the same time.

### Modified Example 1-4

The visual field information generation unit 120 may be configured to be capable of switching between a first mode in which the image comparison processing is performed and a second mode in which the image comparison processing is not performed. This allows a user to select an observation image that is to be displayed as a virtual slide. So, an image of the virtual slide, which is attached to a microscope image, can be prevented from being displayed also in the case where the user wants to use only the microscope apparatus 200 for an observation, and thus the inconvenience can be eliminated.

### Second Embodiment

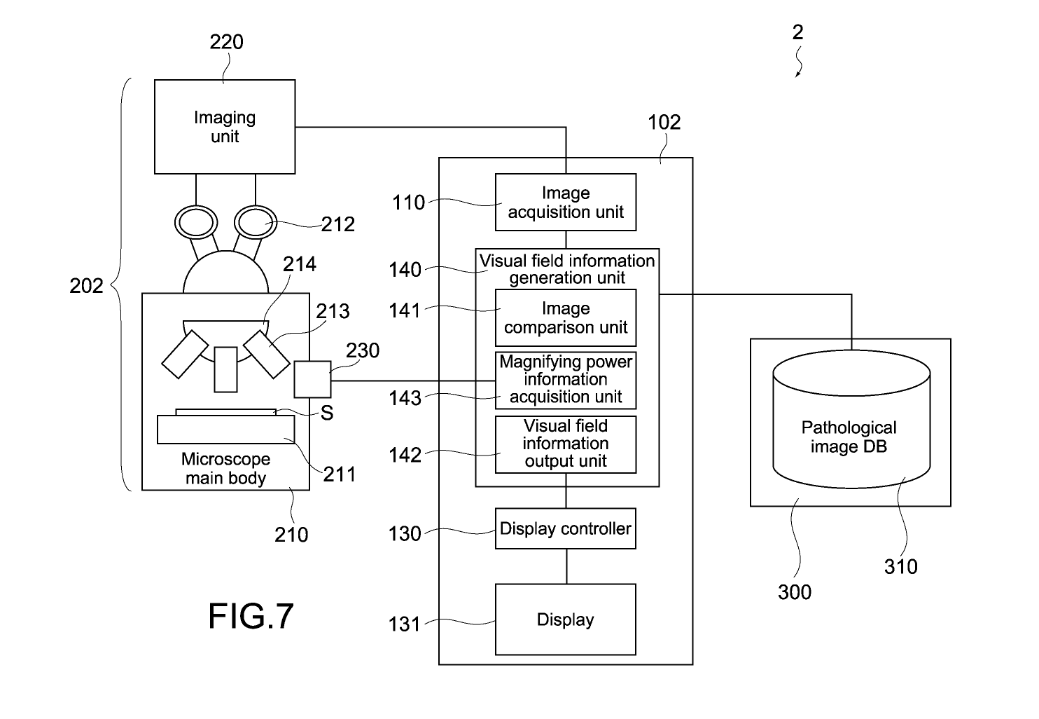

FIG. 7 is a block diagram of an image processing system according to a second embodiment of the present disclosure. An image processing system 2 according to this embodiment includes an image processing apparatus 102, a microscope apparatus 202, and a server apparatus 300 as in the first embodiment.

On the other hand, the second embodiment is different from the first embodiment in that the image processing apparatus 102 is configured to be capable of acquiring information on a magnifying power from the microscope apparatus 202 and in that the image processing apparatus 102 uses information on a magnifying power of an observation image, which is input from the microscope apparatus 202, when visual field information is generated. In the following description, the same configuration as that of the first embodiment will be not described or simply described and a difference will be mainly described.

[Configuration of Microscope Apparatus]

The microscope apparatus 202 includes a microscope main body 210, an imaging unit 220, and a magnifying power information output unit 230. The microscope main body 210 includes a stage 211, an eyepiece lens 212, a plurality of objective lenses 213, and an objective lens holding unit 214 as in the first embodiment.

The magnifying power information output unit 230 is configured to be capable of outputting information on a magnifying power of an observation image to the image processing apparatus 102. A specific configuration of the magnifying power information output unit 230 is not particularly limited. For example, the magnifying power information output unit 230 may have a sensor for detecting a magnifying power of the objective lens 213 disposed on an optical path of the observation image. Alternatively, in the case where the objective lens holding unit 214 is constituted of an electric-powered revolver or the like capable of outputting information on driving, the objective lens holding unit 214 may function as the magnifying power information output unit 230.

[Configuration of Image Processing Apparatus]

The image processing apparatus 102 includes an image acquisition unit 110, a visual field information generation unit 140, a display controller 130, and a display 131.

As in the first embodiment, the visual field information generation unit 140 compares an input image having a first resolution with a virtual slide including an image of an observation target and having a second resolution higher than the first resolution, and thus generates visual field information for identifying a visual field range corresponding to the input image in the virtual slide. The visual field information generation unit 140 uses information on a magnifying power at the time of generation of the visual field information. In other words, the visual field information generation unit 140 acquires the information on the magnifying power of the observation image and uses a ratio of the magnifying power of the virtual slide to the magnifying power of the observation image, to compare the virtual slide with the input image.

Specifically, the visual field information generation unit 140 includes an image comparison unit 141, a visual field information output unit 142, and a magnifying power information acquisition unit 143. The magnifying power information acquisition unit 143 acquires the information on the magnifying power of the observation image output from the microscope apparatus 202. In this embodiment, the magnifying power is used in processing in which the image comparison unit 141 compares the virtual slide with the input image. In the following description, the phrase “the magnifying power of the observation image” may refer to the magnifying power of the objective lens, but may also refer to the magnifying power of the entire optical system of the microscope apparatus 202 including the eyepiece lens and the objective lenses.

The image comparison unit 141 compares the virtual slide with the input image as in the image comparison unit 121 according to the first embodiment. At that time, a ratio of the magnifying power of the virtual slide to the magnifying power of the observation image is used. Further, also in this embodiment, a vote using a SIFT feature amount is performed, and thus the input image and the virtual slide can be compared with each other.

[Operation of Visual Field Information Generation Unit]

Hereinafter, an operation example of the visual field information generation unit 140 will be described with reference to the flowchart of FIG. 3.

The visual field information generation unit 140 acquires an input image from the image acquisition unit 110 (ST11).

Next, the image comparison unit 141 of the visual field information generation unit 140 compares the virtual slide with the input image (ST12). First, the image comparison unit 141 extracts, from the virtual slide, a plurality of first feature points each having a unique SIFT feature amount (ST121). Subsequently, the image comparison unit 141 extracts, from the input image, a plurality of second feature points each having a unique SIFT feature amount (ST122). Here, description will be given assuming that the second feature points Cm6, Cm22, Cm28, Cm36, and Cm87 provided with the code book numbers 6, 22, 28, 36, and 87, which are shown in FIG. 4A, are extracted. Further, the image comparison unit 141 describes a relative relationship between a visual field range of the input image and each SIFT feature amount of the plurality of second feature points (ST123).

Next, the image comparison unit 141 performs a vote of a reference point and a visual field vector on each of the plurality of first feature points corresponding to the plurality of respective second feature points, based on results obtained in ST123 (ST124). In this step, at the time of the vote, the image comparison unit 141 extracts only a first feature point Cvn having a scale σv, with which a ratio (σv/σm) of a magnitude σv of the scale of the SIFT feature amount related to the first feature point Cvn to a magnitude am of the scale of the SIFT feature amount related to the second feature point Cmn becomes equal to a ratio (Σv/τm) of the magnifying power Σv of the virtual slide to the magnifying power Σm of the input image (the magnifying power of the observation image). Subsequently, the image comparison unit 141 performs a vote for the first feature point Cvn as a target.

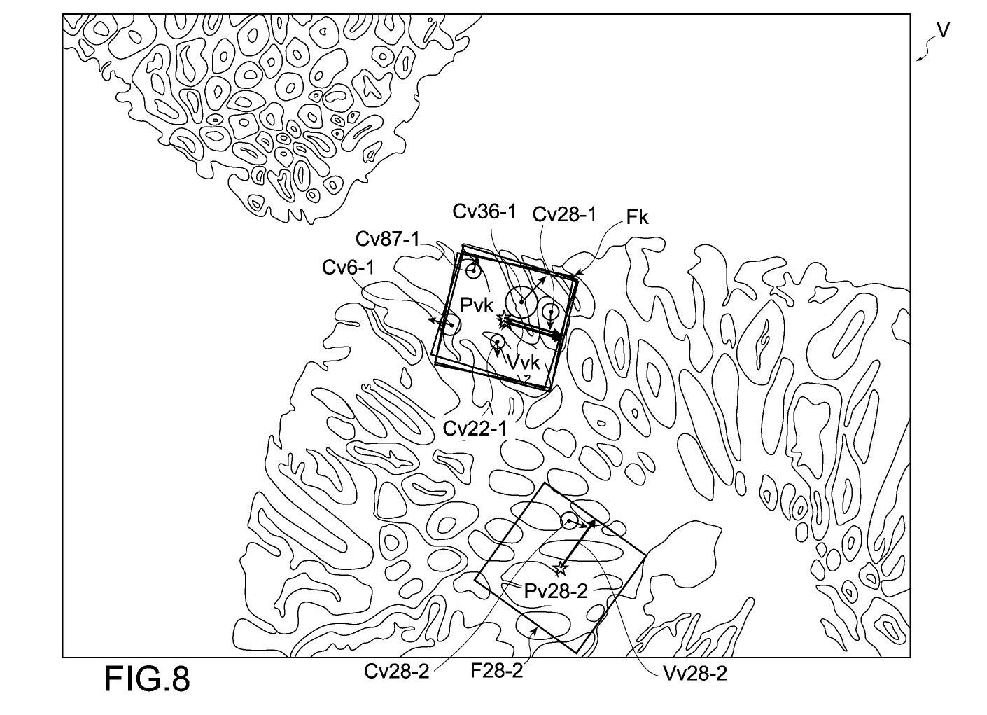

FIG. 8 is a schematic diagram showing a result of a vote performed on each first feature point of the virtual slide in this embodiment and corresponds to FIG. 5. As shown in FIG. 8, the number of first feature points Cvn used in the vote is largely reduced as compared with FIG. 5. Thus, the costs for the vote processing in this step can be reduced.

It should be noted that the magnifying power of an actual observation image may slightly fluctuate depending on conditions of a focus of an optical system of the microscope apparatus 202, or the like, even in the case of using objective lenses having a single magnifying power. In this regard, in consideration of this fluctuation, it is possible to provide some range to the scale σv of the first feature point Cvn that is to be a vote target.

The image comparison unit 141 calculates the degree of correlation between each visual field range candidate and the input image based on results of the votes (ST125) and determines that a visual field range candidate having the largest degree of correlation is a visual field range corresponding to the input image (ST126). Finally, the visual field information output unit 142 generates visual field information for identifying a visual field range corresponding to the input image based on the result of the comparison (ST13) and outputs the visual field information to the display controller 130 (ST14).

As described above, in this embodiment, it is possible to reduce not only costs for the vote processing but also costs for clustering processing and the like performed after the vote. As a result, it is possible to largely reduce processing costs for the comparison processing as a whole. So, it is possible to enhance following performance of the virtual slide with respect to the input image and provide a configuration with higher operability.

### Modified Example 2-1

A configuration in which the microscope apparatus 202 does not include the magnifying power information output unit 230 and the image processing apparatus 102 is capable of receiving an input of information on a magnifying power of an observation image from a user may be provided as a modified example of this embodiment. In this case, the user can check the magnifying power of the objective lens 213 disposed on an optical path of the observation image of the microscope apparatus 202 and input such information into the image processing apparatus 102. With this operation as well, processing costs for the visual field information output unit 142 can be reduced.

### Third Embodiment

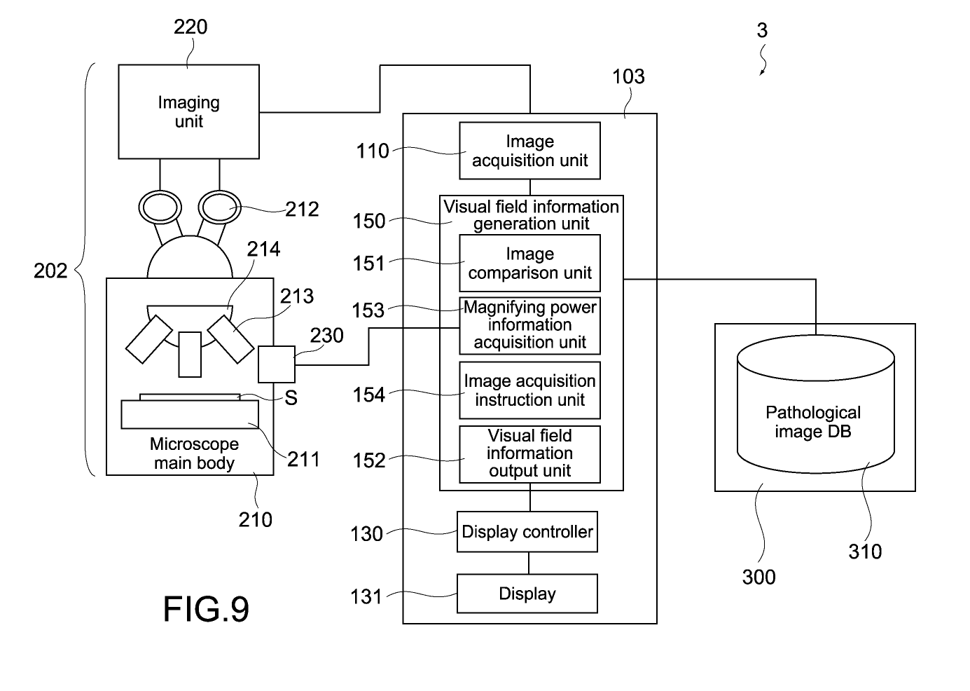

FIG. 9 is a block diagram of an image processing system according to a third embodiment of the present disclosure. An image processing system 3 according to this embodiment includes an image processing apparatus 103, a microscope apparatus 202, and a server apparatus 300 as in the first embodiment. On the other hand, the third embodiment is different from the first embodiment in that the image processing apparatus 103 is configured to be capable of acquiring information on a magnifying power of an observation image from the microscope apparatus 202 and in that processing using the information on the magnifying power can be performed when image comparison fails. In the following description, the same configuration as that of the first embodiment will be not described or simply described and a difference will be mainly described.

[Configuration of Microscope Apparatus]

The microscope apparatus 202 includes a microscope main body 210, an imaging unit 220, and a magnifying power information output unit 230 as in the second embodiment. The microscope main body 210 includes a stage 211, an eyepiece lens 212, a plurality of objective lenses 213, and an objective lens holding unit 214 as in the first embodiment.

The magnifying power information output unit 230 is configured to be capable of outputting information on a magnifying power of an observation image to the image processing apparatus 103. A specific configuration of the magnifying power information output unit 230 is not particularly limited. For example, the magnifying power information output unit 230 may have a sensor for detecting a magnifying power of the objective lens 213 disposed on an optical path of the observation image. Alternatively, in the case where the objective lens holding unit 214 is constituted of an electric-powered revolver or the like capable of outputting information on driving, the objective lens holding unit 214 may function as the magnifying power information output unit 230.

[Configuration of Image Processing Apparatus]

The image processing apparatus 103 includes an image acquisition unit 110, a visual field information generation unit 150, a display controller 130, and a display 131.

As in the first embodiment, the visual field information generation unit 150 compares an input image having a first resolution with a virtual slide including an image of an observation target and having a second resolution higher than the first resolution, and thus generates visual field information for identifying a visual field range corresponding to the input image in the virtual slide. In addition to this, the visual field information generation unit 150 is configured to be capable of instructing a user to capture another observation image of a slide specimen being observed, when failing to generate visual field information. Specifically, the visual field information generation unit 150 includes an image comparison unit 151, a visual field information output unit 152, a magnifying power information acquisition unit 153, and an image acquisition instruction unit 154.

The image comparison unit 151 compares the virtual slide with the input image. Based on a result of the comparison, the visual field information output unit 152 calculates a visual field range corresponding to the input image in the virtual slide and outputs visual field information for identifying the visual field range to the display controller 130.

The magnifying power information acquisition unit 153 acquires information on a magnifying power of an observation image output from the microscope apparatus 202. The information on the magnifying power is used for processing in the case where the image acquisition instruction unit 154 fails to generate the visual field information. In the following description, the phrase “magnifying power” refers to the magnifying power of the objective lens but may also refer to the magnifying power of the entire optical system of the microscope apparatus 202 including the eyepiece lens and the objective lenses.

When failing to generate the visual field information, the image acquisition instruction unit 154 instructs the user to capture another observation image of the slide specimen. Examples of such an instruction include an instruction to acquire an input image having a small magnifying power, that is, a low-power field, and an instruction to move the slide specimen placed on the stage 211 of the microscope apparatus 202.

[Operation of Visual Field Information Generation Unit]

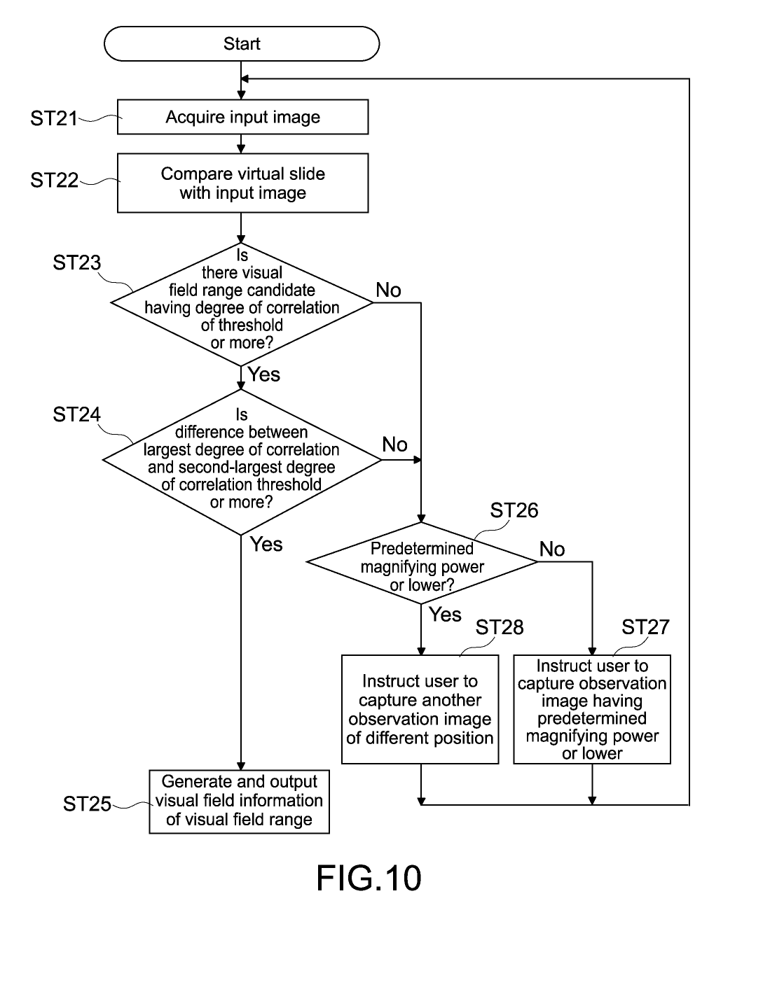

FIG. 10 is a flowchart showing an operation example of the visual field information generation unit 150. The visual field information generation unit 150 acquires an input image from the image acquisition unit 110 (ST21).

Next, the image comparison unit 151 of the visual field information generation unit 150 compares the virtual slide with the input image (ST22). In this embodiment as well, the visual field information generation unit 150 compares the virtual slide with the input image based on a plurality of SIFT feature amounts extracted from the virtual slide and on a plurality of SIFT feature amounts extracted from the input image. Specific processing of this step (ST22) is performed as in ST121 to ST125 included in ST12 of FIG. 3 according to the first embodiment, and thus description thereof will be given with reference to FIG. 3.

In other words, the image comparison unit 151 extracts, from the virtual slide, a plurality of first feature points each having a unique SIFT feature amount (corresponding to ST121). Next, the image comparison unit 151 extracts, from the input image, a plurality of second feature points each having a unique SIFT feature amount (corresponding to ST122). Subsequently, the image comparison unit 151 calculates a relationship between each of the second feature points and a visual field range of the input image (corresponding to ST123). Further, the image comparison unit 151 performs a vote of a reference point and a visual field vector on each of the plurality of first feature points corresponding to the plurality of respective second feature points, based on the relationship described above (corresponding to ST124). Subsequently, the image comparison unit 151 calculates the degree of correlation between each visual field range candidate and the input image based on results of the votes (corresponding to ST125). The degree of correlation can be calculated by Expression (5) described above.

Next, the image comparison unit 151 determines whether there is a visual field range candidate with the degree of correlation of a first threshold or more (ST23). The “first threshold” can be set as appropriate by referring to the number of code books or the like of the first feature points extracted from the virtual slide. When such a visual field range candidate is not present, even when the visual field range candidate has the largest degree of correlation, there is a high possibility that a visual field range corresponding to the input image is not obtained and image comparison fails. So, the image acquisition instruction unit 154 performs the following comparison failure processing (ST26 to ST28).

In other words, when it is determined that there are no visual field range candidates with the degree of correlation of the first threshold or more (No in ST23), the image acquisition instruction unit 154 determines whether the magnifying power of the observation image obtained by the magnifying power information acquisition unit 153 is a predetermined magnifying power or lower (ST26). For example, the image acquisition instruction unit 154 can determine whether the magnifying power of the objective lens is 1.25× or lower.

In the determination on “whether the magnifying power is a predetermined magnifying power or lower”, it may be determined “whether an objective lens having a specific magnifying power as the predetermined magnifying power or lower is used or not”. As described above, the magnifying power is a unique numerical value of each objective lens 213. Each objective lens 213 has a predetermined numerical value of the magnifying power of 1.25×, 2.5×, 5×, 10×, 40×, or the like. So, for example, in the case where whether the magnifying power is 2.5× or lower is determined, whether an objective lens having any of 2.5× or 1.25× is used or not only needs to be determined. Alternatively, for example, when it is obvious that the objective lens 213 having a magnifying power less than 1.25× is not attached to the microscope apparatus 202, it may be determined whether the objective lens has 1.25× or not.

When it is determined that the magnifying power of the observation image currently seen is not the predetermined magnifying power or lower (No in ST26), the image acquisition instruction unit 154 instructs a user to capture an observation image having the predetermined magnifying power or lower (ST27). Specific contents of the instruction are not particularly limited as long as the instruction prompts the user to “capture an observation image having a predetermined magnifying power or lower”.

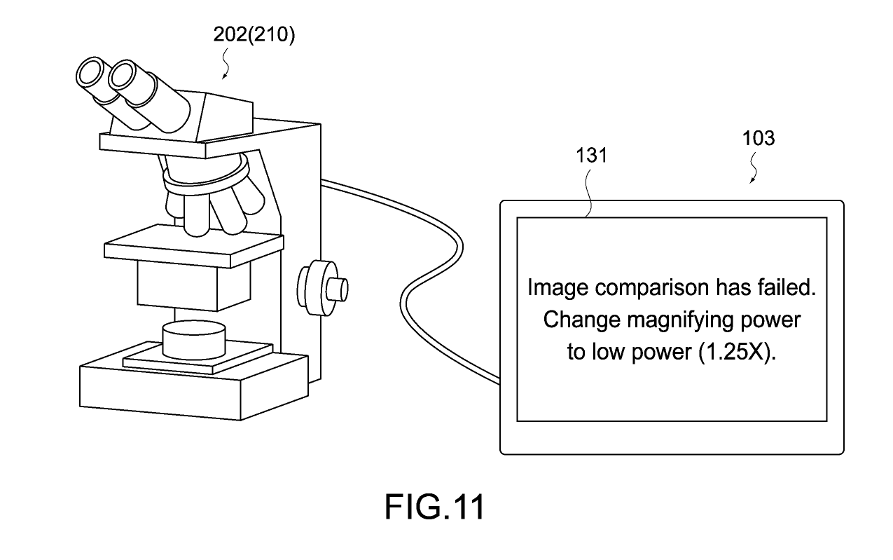

FIG. 11 is a diagram showing an example in which the instruction from the image acquisition instruction unit 154 is displayed on the display 131. As shown in FIG. 11, the image acquisition instruction unit 154 may instruct the user to change the magnifying power of the objective lens 213 to 1.25×. Further, a method of giving an instruction is not limited to the method via the display 131 as shown in FIG. 11. In the case where the image processing apparatus 103 includes a speaker or the like (not shown), the instruction may be given via the speaker or the like.

The magnifying power of the objective lens is reduced, and thus the image acquisition unit 110 can acquire an input image having a broader visual field range. The input image having a broader visual field range has a high possibility of having many characteristic parts as compared with an input image having a narrow visual field range, and has an advantage that a lot of SIFT feature amounts are likely to be extracted. So, when the user is instructed to capture an observation image with a reduced magnifying power to compare images again, a possibility that image comparison succeeds can be increased.

After the instruction described above is given, the visual field information generation unit 150 acquires an input image again from the image acquisition unit 110 (ST21), and the image comparison unit 151 performs image comparison processing (ST22).

On the other hand, when it is determined that the magnifying power is the predetermined magnifying power or lower (Yes in ST26), the image acquisition instruction unit 154 instructs the user to capture another observation image that is different in position on the slide specimen from the observation image currently seen (ST28). Specific contents of the instruction are not particularly limited as long as the instruction prompts the user to “capture another observation image that is different in position on the slide specimen from the observation image currently seen”.

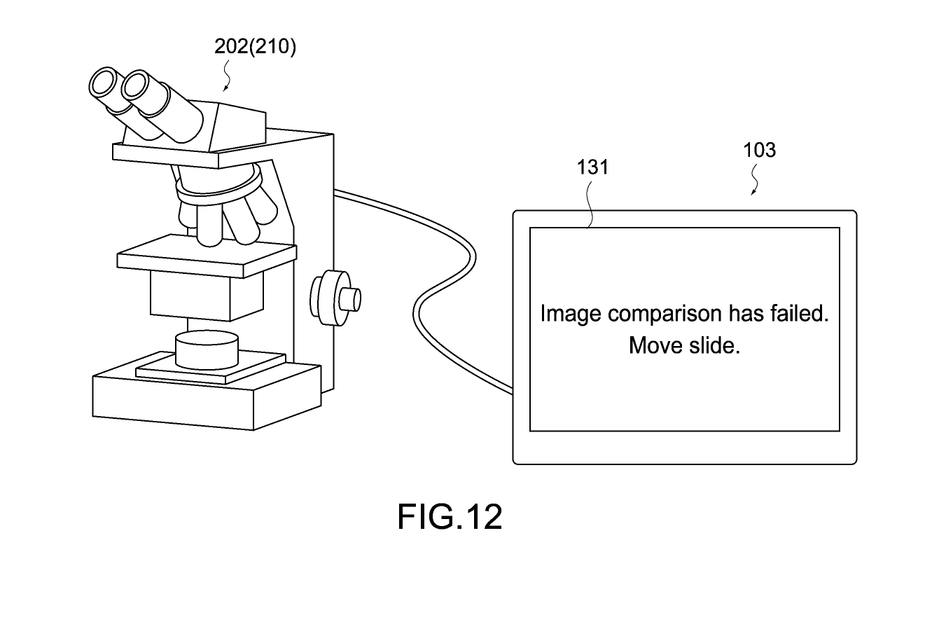

FIG. 12 is a diagram showing an example in which the instruction from the image acquisition instruction unit 154 is displayed on the display 131. Specifically, as shown in FIG. 12, the image acquisition instruction unit 154 may instruct the user to move the slide specimen placed on the stage 211 of the microscope apparatus 202. Further, a method of giving an instruction is not limited to the method via the display 131 as shown in FIG. 12. In the case where the image processing apparatus 103 includes a speaker or the like (not shown), the instruction may be given via the speaker or the like.

When the position of the observation image on the slide specimen is moved, there is provided a possibility that an image having many characteristic parts can be acquired. So, image comparison processing is performed again after the instruction described above is given, and thus a possibility that image comparison succeeds can be increased.

After the instruction described above is given, the visual field information generation unit 150 acquires an input image again from the image acquisition unit 110 (ST21), and the image comparison unit 151 performs image comparison processing (ST22).

Returning to the image comparison processing, when it is determined that there is a visual field range candidate with the degree of correlation of a first threshold or larger (Yes in ST23), the image comparison unit 151 determines whether a difference in degree of correlation between a visual field range candidate having the largest degree of correlation and a visual field range candidate having the second-largest degree of correlation is a second threshold or more (ST24). The “second threshold” is not particularly limited and may be set as appropriate.

In general, it is thought that a visual field range corresponding to the input image is one portion in the virtual slide. For that reason, it is assumed that a difference in degree of correlation between a visual field range corresponding to the input image and the other areas is large. In this regard, when it is determined that a difference in degree of correlation is a second threshold or more (Yes in ST24), the visual field information output unit 152 generates visual field information corresponding to a visual field range having the largest degree of correlation and outputs the visual field information to the display controller 130 (ST25).

On the other hand, when it is determined that a difference in degree of correlation is less than the second threshold (No in ST24), the comparison failure processing is performed (ST26 to ST28) because of a high possibility that the image comparison has failed.

As described above, according to this embodiment, even when the image comparison fails, with an instruction given to the user, the image comparison can be performed again. With this operation, the image comparison processing can be advanced smoothly without giving excessive stress involving the failure of the image comparison to the user. Further, when an adequate instruction is presented to the user, this leads to an efficient success in the image comparison processing. So, operability of the virtual slide by the microscope apparatus 200 can be more enhanced. Hereinafter, modified examples 3-1 to 3-3 according to this embodiment will be described.

### Modified Example 3-1

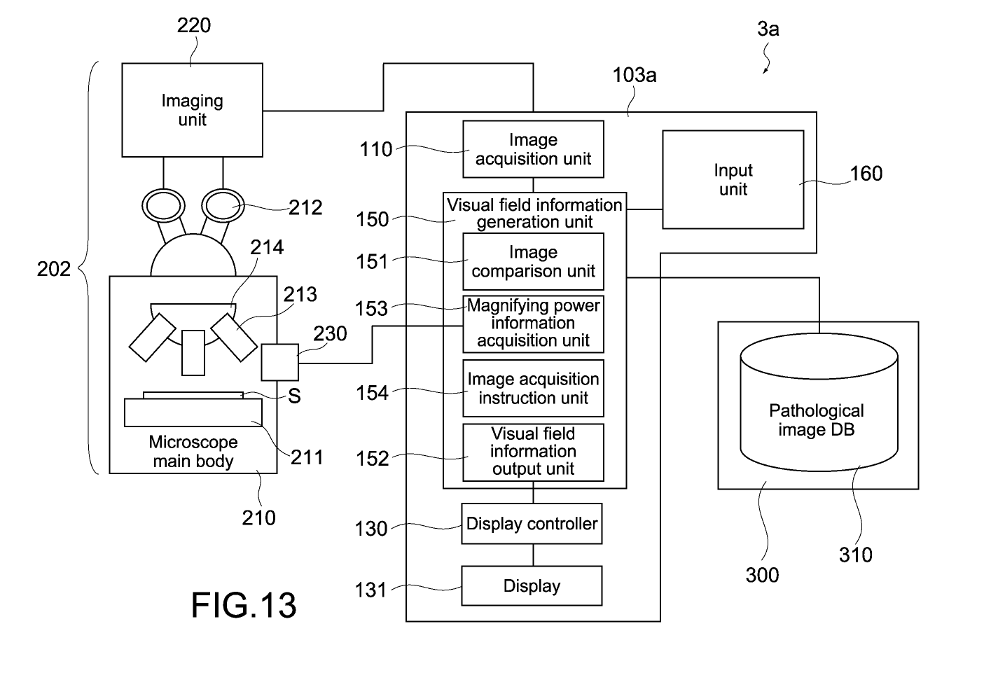

FIG. 13 is a block diagram of an image processing system 3a according to this modified example. An image processing apparatus 103a of this modified example is different from the image processing apparatus 103 in that the image processing apparatus 103a includes an input unit 160 in addition to the image acquisition unit 110, the visual field information generation unit 150, the display controller 130, and the display 131. With this configuration, even when a reliable visual field range is not found and several visual field range candidates are found, the user can select a proper visual field range by using the input unit 160.

The input unit 160 is configured such that the user can select a visual field range from a plurality of visual field range candidates displayed on the display 131. A specific configuration of the input unit 160 is not particularly limited. For example, the input unit 160 may be a touch panel, a pointing device such as a mouse, a keyboard device, or the like.

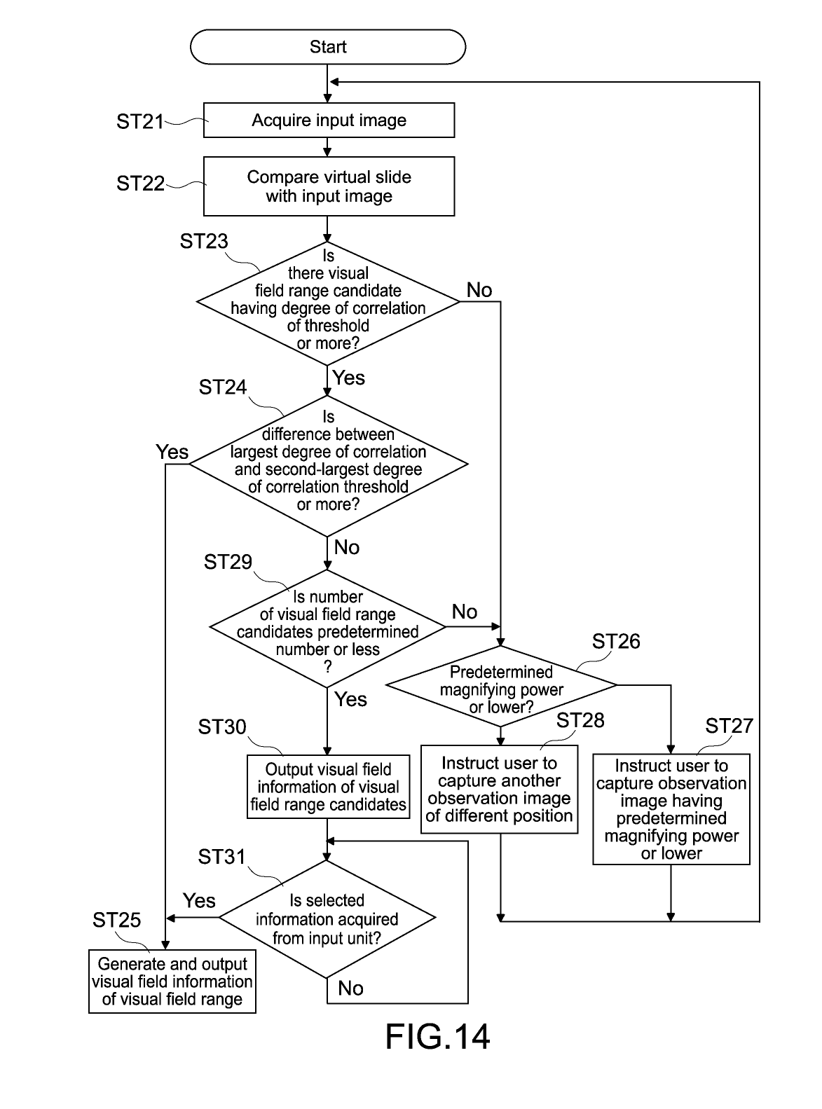

FIG. 14 is a flowchart showing an operation example of the visual field information generation unit 150 according to this modified example. After the step of determining whether a difference in degree of correlation between a visual field range candidate having the largest degree of correlation and a visual field range candidate having the second-largest degree of correlation is a second threshold or more (ST24), processing that is different from the processing of the flowchart of FIG. 10 is performed. So, this difference will be mainly described.

When it is determined that a difference in degree of correlation is a second threshold or more (Yes in ST24), the visual field information output unit 152 generates visual field information corresponding to a visual field range having the largest degree of correlation and outputs the visual field information to the display controller 130 (ST25), as in the processing of FIG. 10.

On the other hand, when it is determined that a difference in degree of correlation is less than the second threshold (No in ST24), the image comparison unit 151 determines whether the number of visual field range candidates, in each of which the difference in degree of correlation between the visual field range candidate having the largest degree of correlation and the visual field range candidate having the second-largest degree of correlation is less than the second threshold, is a predetermined number or less (ST29). Here, the “predetermined number” only needs to be a number with which the user can select a proper visual field range from the visual field range candidates, and is a number such as about 2 to 20, for example. In the case where the number of visual field range candidates is larger than the predetermined number (No in ST29), it is difficult for the user to select a proper visual field range, and thus the comparison failure processing is performed (ST26 to ST28).

On the other hand, in the case where the number of visual field range candidates is the predetermined number or less (Yes in ST29), the visual field information output unit 152 outputs visual field information to the display controller 130, the visual field information corresponding to the plurality of visual field range candidates with the difference in degree of correlation of the second threshold or less (ST30).

With this operation, information on the plurality of visual field range candidates is displayed on the display 131. For example, thumbnail images or the like of the visual field range candidates may be displayed on the display 131. Further, a slide ID included in the visual field information, a patient name, and the like may be displayed. The user selects a proper visual field range as a visual field range corresponding to the input image, from those visual field range candidates, and selects the proper visual field range with use of the input unit 160. Examples of an input operation in this case may include, in the case where the input unit 160 is constituted of a touch panel, a touch operation on an image or the like of a visual field range to be selected.

The visual field information output unit 152 determines whether information on the visual field range selected by the user is acquired by the input unit 160 or not (ST31). When it is determined that the information is not acquired (No in ST31), it is determined again whether that information is acquired or not (ST31). On the other hand, when it is determined that the information is acquired (Yes in ST31), visual field information corresponding to the selected visual field range is generated and output to the display controller 130 (ST25).

In such a manner, according to this modified example, in the case of narrowing the visual field range candidates, it is possible for the user to select a proper visual field range. So, more rapid processing can be performed than the comparison failure processing. Further, since the user determines a proper visual field range candidate, erroneous processing of the visual field information generation unit 150 can be prevented even when there are confusing visual field range candidates. Further, as compared with the case where the image comparison processing is performed, processing costs of the visual field information generation unit 150 can be reduced.

### Modified Example 3-2

When determining that there are no visual field range candidates with the degree of correlation of the first threshold or more by the comparison between the virtual slide and the input image (No in ST23 of FIG. 10), the visual field information generation unit 150 may instruct the user to capture another observation image of the slide specimen, without determining whether the magnifying power is a predetermined magnifying power or lower. With this operation, even when magnifying power information is not acquired, image comparison can be performed again when the image comparison fails.

Specific contents of the instruction are not particularly limited as long as the instruction prompts the user to “capture another observation image of the slide specimen”. For example, a phrase “Perform image comparison again.” may be displayed on the display 131. This can also enhance a possibility that the user captures another observation image and thus image comparison succeeds. So, processing costs of the visual field information generation unit 150 can be reduced.

### Modified Example 3-3

As in the configuration example 1 of the modified example 1-2, after generating first visual field information from a certain input image and in the case of generating second visual field information from another input image, the visual field information generation unit 150 can compare an area in the virtual slide corresponding to a slide ID obtained from the first visual field information with the input image.

Further, in this modified example, assuming that comparison is repeated in an area in the virtual slide corresponding to the same slide ID, in the case where a determination on that there are no visual field range candidates with the degree of correlation of the first threshold or more (see ST23 of FIG. 10) is performed on a predetermined number or more of input images, the entire virtual slide and the input image can be compared with each other. In other words, in the case where the comparison processing is performed in the virtual slide corresponding to the same slide ID, when the comparison failure processing is repeated by a predetermined number of times or more, the slide specimen is considered to be switched, and the entire virtual slide is set to a comparison target. This allows costs of the image comparison processing to be largely reduced. In addition thereto, this allows the switching of the slide specimen to be automatically determined, and this can improve convenience.

### Fourth Embodiment

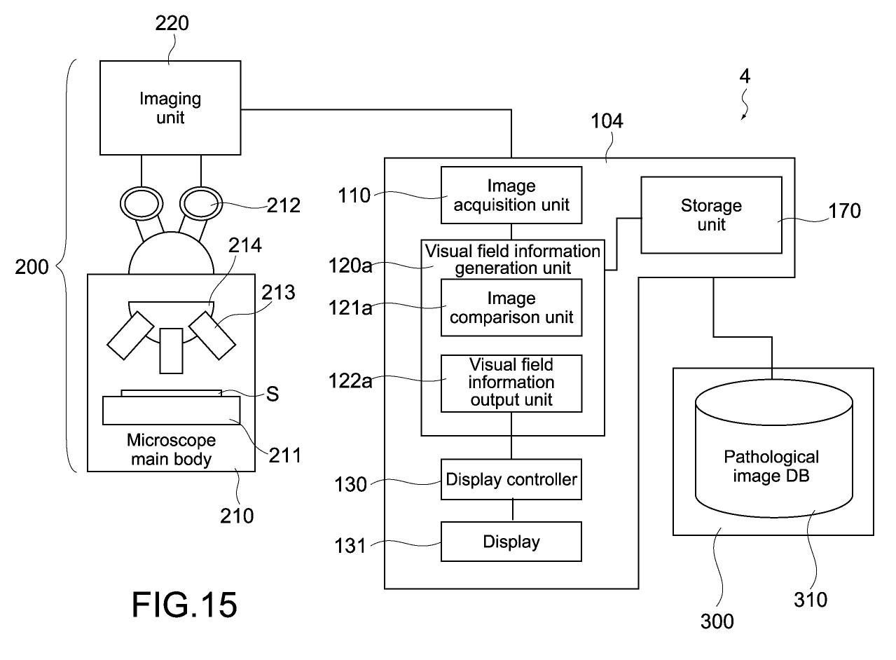

FIG. 15 is a block diagram of an image processing system according to a fourth embodiment of the present disclosure. An image processing system 4 according to this embodiment includes an image processing apparatus 104, a microscope apparatus 200, and a server apparatus 300 including a pathological image DB 310, as in the first embodiment. The fourth embodiment is different from the first embodiment in that the image processing apparatus 104 further includes a storage unit 170. Hereinafter, description on the same configurations as those in the first embodiment will be omitted or simplified and only differences will be mainly described.

The image processing apparatus 104 includes an image acquisition unit 110, a visual field information generation unit 120a, a display controller 130, a display 131, and the storage unit 170.

The storage unit 170 is configured to be capable of storing all or some of virtual slides stored in the pathological image DB 310. In other words, the image processing apparatus 104 can download a virtual slide from the server apparatus 300 as appropriate and store the virtual slide in the storage unit 170. Specifically, the storage unit 170 can be constituted of a non-volatile memory such as an HDD or an SSD.

The visual field information generation unit 120a is configured as in the first embodiment and includes an image comparison unit 121a and a visual field information output unit 122a. As with the visual field information output unit 122 according to the first embodiment, the visual field information output unit 122a calculates a visual field range corresponding to an input image in the virtual slide based on a result of the comparison and outputs visual field information for identifying the visual field range to the display controller 130.

The image comparison unit 121a compares the virtual slide and the input image as described above. The image comparison unit 121a can advance the image comparison processing by using the virtual slide stored in the storage unit 170, unlike the first embodiment. Further, the image comparison unit 121a can previously execute part of the image comparison processing on the virtual slide held in the storage unit 170. For example, prior to the image comparison processing, the image comparison unit 121a can extract a plurality of first feature points from the virtual slide. The plurality of first feature points have respective unique SIFT feature amounts.

In such a manner, according to this embodiment, processing time from the acquisition of the input image to the generation of the visual field information can be shortened. This allows a waiting time of a user to be shortened and a diagnostic efficiency to be improved. Further, in the case where the image processing apparatus 104 is used in a medical interview of a patient or the like, consultation time can also be shortened. Further, in the case of storing some of the virtual slides stored in the pathological image DB 310, the storage unit 170 can store various contents of virtual slides. Examples of such a case will be described below.

(Regarding Contents of Virtual Slides Stored in Storage Unit)

For example, after generating first visual field information from a certain input image, the storage unit 170 can store a virtual slide having an area corresponding to a slide ID obtained by the first visual field information. Thus, as described in the configuration example 1 of the modified example 1-2, when the visual field information generation unit 120a generates first visual field information from a certain input image and subsequently generates second visual field information from another input image, the visual field information generation unit 120a can compare the area in the virtual slide stored in the storage unit 170 with the input image. So, costs for the image comparison processing can be largely reduced and processing time can be shortened.

For example, the storage unit 170 can store a virtual slide having an area corresponding to a slide specimen of the same patient. This easily allows a change or progression of a clinical condition of the same patient to be grasped adequately. Further, referring to the modified example 1-1, the storage unit 170 can also store annotation information associated with the stored virtual slide. This can advance a diagnosis more efficiently.

### Fifth Embodiment

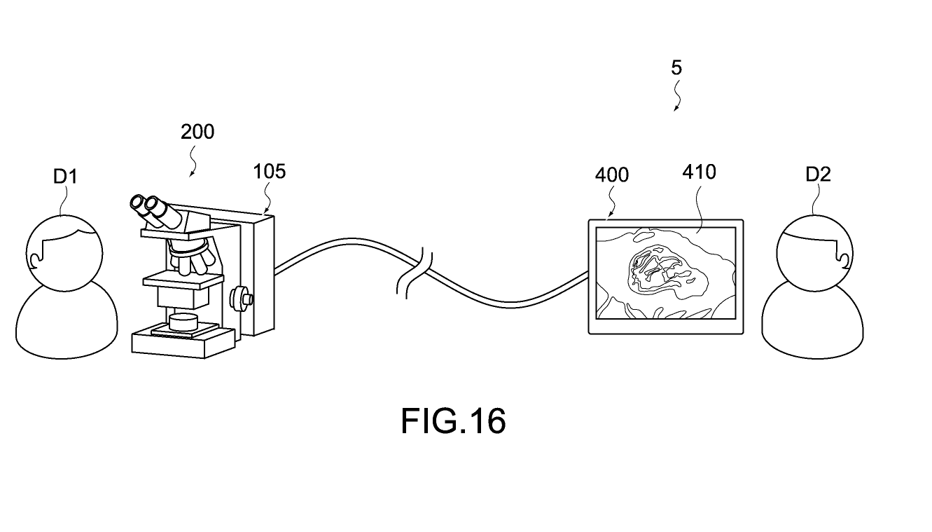

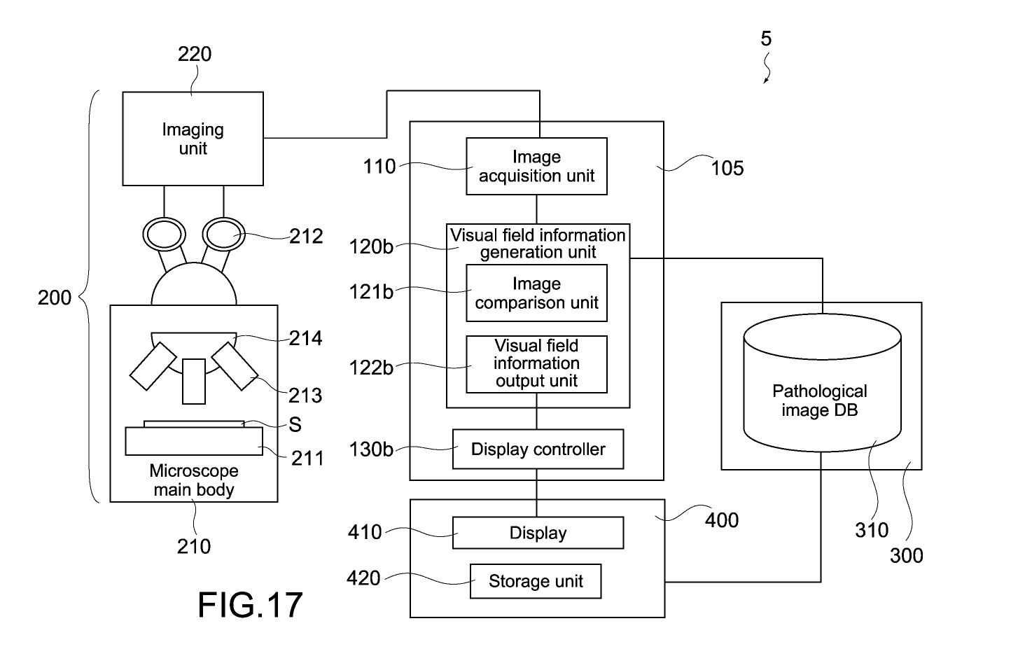

FIG. 16 is a schematic diagram of an image processing system 5 according to a fifth embodiment of the present disclosure. FIG. 17 is a block diagram of the image processing system 5. The image processing system 5 according to this embodiment further includes a display apparatus 400 in addition to an image processing apparatus 105, a microscope apparatus 200, and a server apparatus 300 including a pathological image DB 310. Hereinafter, description on the same configurations as those in the first embodiment will be omitted or simplified and only differences will be mainly described.

The image processing system 5 can be used in a remote diagnosis by a medical doctor D1 and a medical doctor D2 as shown in FIG. 16. The image processing apparatus 105 is disposed on the medical doctor D1 side together with the microscope apparatus 200. On the other hand, the display apparatus 400 is disposed on the medical doctor D2 side. A communication method between the image processing apparatus 105 and the display apparatus 400 is not particularly limited and may be communication via a network, for example.

The image processing apparatus 105 includes an image acquisition unit 110, a visual field information generation unit 120b, and a display controller 130b. The image processing apparatus 105 may have a configuration excluding a display, unlike the first embodiment and the like. The image processing apparatus 105 may be configured as an information processing apparatus such as a PC or a tablet terminal.

The visual field information generation unit 120b includes an image comparison unit 121b and a visual field information output unit 122b. The image comparison unit 121b is configured as the image comparison unit 121 according to the first embodiment and compares a virtual slide with an input image.

The visual field information output unit 122b calculates a visual field range corresponding to the input image in the virtual slide, based on a result of the comparison and outputs visual field information for identifying the visual field range to the display controller 130b.

The display controller 130b acquires information corresponding to the visual field range corresponding to the input image in the virtual slide, based on the visual field information, and outputs a signal for displaying the information to the display apparatus 400. The information can be the output image.

The display apparatus 400 includes a display 410 and a storage unit 420 and is connected to the image processing apparatus 105 in a wired or wireless manner. The display apparatus 400 may be configured as an information processing apparatus such as a PC or a tablet terminal.

The display 410 displays the information based on the signal output from the display controller 130b. The display 410 is a display device using an LCD or an GELD, for example, and may be constituted as a touch panel display.

The storage unit 420 is configured to be capable of storing all or some of the virtual slides. In other words, the display apparatus 400 can download a virtual slide as appropriate and store the virtual slide in the storage unit 420. A method of downloading a virtual slide by the display apparatus 400 is not particularly limited. Downloading may be performed directly from the server apparatus 300 or via the image processing apparatus 105. Specifically, the storage unit 420 can be constituted of a non-volatile memory such as an HDD or an SSD.

The image processing system 5 can be used in a remote diagnosis as described above. For example, the medical doctor D1 shown in FIG. 16 is a medical doctor who requests a pathological diagnosis and the medical doctor D2 shown in FIG. 16 is a medical specialist or the like of a pathological diagnosis and medical doctor who is requested to perform a pathological diagnosis. The medical doctor D1 wants to request the medical doctor D2 to perform a diagnosis based on a slide specimen of a patient, which is held in hand of the medical doctor D1. Hereinafter, under such an assumption, an operation example of the image processing apparatus 105 and the display apparatus 400 will be described.

(Operation Example of Image Processing Apparatus and Display Apparatus)

First, the image acquisition unit 110 of the image processing apparatus 105 acquires an input image from the microscope apparatus 200, the input image being captured by the medical doctor D1, and outputs the input image to the visual field information generation unit 120b.

The image comparison unit 121b compares the virtual slide with the input image. As in the embodiments described above, a virtual slide stored in the pathological image DB 310 of the server apparatus 300 can be used as the virtual slide described here. The visual field information output unit 122b outputs visual field information for identifying a visual field range corresponding to the input image to the display controller 130b based on a result of the comparison. The display controller 130b outputs a signal for displaying the output image, which corresponds to the visual field range of the input image in the virtual slide, to the display apparatus 400 based on the visual field information.

On the other hand, the virtual slide is previously transmitted to the display apparatus 400 on the medical doctor D2 side. The virtual slide may be transmitted from the server apparatus 300 directly or via the image processing apparatus 105. It should be noted that the transmitted virtual slide can be a copy of the virtual slide stored in the server apparatus 300. The virtual slide transmitted to the display apparatus 400 is stored in the storage unit 420.

The display 410 of the display apparatus 400 that has received the signal from the display controller 130b uses the virtual slide stored in the storage unit 420 to display, as an output image, a visual field range of the virtual slide corresponding to the visual field information. Thus, the medical doctor D2 can check the output image of the virtual slide, which corresponds to the input image observed by the medical doctor D1. In such a manner, according to this embodiment, it is not necessary to transmit the input image itself from the image processing apparatus 105 to the display apparatus 400, and it is only necessary to transmit the visual field information. So, data amount transmitted when one piece (one frame) of the output image is output can be reduced.

On the other hand, in the past, an input image (microscope image) captured by the medical doctor D1 has been directly transmitted to the display apparatus 400 of the medical doctor D2. So, there has been a problem that in the case where the medical doctor D1 successively captures microscope images while moving a slide specimen, a frame rate is reduced due to a large data transmission amount of one microscope image. As a result, following performance of the output image for the medical doctor D2 with respect to the movement of the slide specimen by the medical doctor D1 has been poor and it has been difficult to smoothly perform a remote diagnosis.

In this regard, according to this embodiment, data amount in communication can be largely reduced as compared with the remote diagnosis in related art. This allows costs of data transmission in a pathological diagnosis to be suppressed. Further, the following performance of the output image for the medical doctor D2 with respect to the movement of the slide specimen by the medical doctor D1 can be enhanced. This allows the microscope image observed by the medical doctor D1 to be presented to the medical doctor D2 at a low latency and a high frame rate. So, a remote diagnosis can be performed more smoothly.

Hereinabove, the embodiments of the present disclosure have been described. The present disclosure is not limited to the embodiments described above and can be variously modified without departing from the gist of the present disclosure. Hereinafter, other modified examples 5-1 to 5-3 will be described.

### Modified Example 5-1

The visual field information generation unit may generate first visual field information from a certain input image and subsequently generate second visual field information based on information on a displacement of a slide specimen, which is obtained from the microscope apparatus. Specifically, the microscope apparatus can have a configuration including a displacement detection unit that acquires information on a displacement in the plane of a stage. A specific configuration of the displacement detection unit is not particularly limited, and the displacement detection unit may be capable of detecting a displacement itself in the plane of the stage, for example. Alternatively, a configuration capable of detecting a speed in the plane of the stage may be provided.

The visual field information generation unit of the image processing apparatus is configured to be capable of calculating a displacement amount of a virtual slide based on information on a displacement of the stage, which is output from the displacement detection unit of the microscope apparatus. Further, the visual field information generation unit is configured to be capable of generating second visual field information by adding the calculated displacement amount of the virtual slide to the first visual field information. According to this modified example, the image processing apparatus can largely reduce processing costs of image comparison.

### Modified Example 5-2

In the embodiments described above, the image processing apparatus is constituted as an information processing apparatus such as a PC or a tablet terminal, but the present disclosure is not limited thereto. For example, an image acquisition unit, a display controller, and the like may be stored in a first apparatus main body such as a PC or a tablet terminal, and a visual field information generation unit of the image processing apparatus may be stored in a second apparatus main body such as a PC or a server connected to the first apparatus main body. Specifically, in this case, the image processing apparatus includes the first apparatus main body and the second apparatus main body. With this configuration, even when data processing amount related to image comparison is large, a load on each apparatus main body can be reduced. Further, the second apparatus main body may be a server apparatus that stores a pathological image DB.

### Modified Example 5-3

In the embodiments described above, the image processing system including the image processing apparatus is used in a pathological image diagnosis, but the present disclosure is not limited thereto. For example, in the studies of the fields of physiology, pharmacology, and the like, the present disclosure can be applied when a tissue slice is observed.

It should be noted that the present disclosure can have the following configurations:

(1) An image processing apparatus, including:

an image acquisition unit configured to acquire an input image having a first resolution, the input image being generated by capturing an observation image of an observation target of a user;

a visual field information generation unit configured to compare a specimen image with the input image, the specimen image including an image of the observation target and having a second resolution that is higher than the first resolution, to generate visual field information for identifying a visual field range corresponding to the input image in the specimen image; and

a display controller configured to acquire information corresponding to the visual field range in the specimen image, based on the visual field information, and output a signal for displaying the information.

(2) The image processing apparatus according to (1), in which

the visual field information generation unit is configured to acquire information on a magnifying power of the observation image and compare the specimen image with the input image by using a ratio of a magnifying power of the specimen image to the magnifying power of the observation image.

(3) The image processing apparatus according to (1) or (2), in which

the visual field information generation unit is configured to instruct, when failing to generate the visual field information, a user to capture another observation image of the observation target.

(4) The image processing apparatus according to (3), in which

the visual field information generation unit is configured to

determine, when failing to generate the visual field information, whether the magnifying power of the observation image is a predetermined magnifying power or lower, and

instruct, when the magnifying power of the observation image is not the predetermined magnifying power or lower, the user to capture an observation image with the predetermined magnifying power or lower.

(5) The image processing apparatus according to (3), in which

the visual field information generation unit is configured to instruct, when failing to generate the visual field information, the user to capture another observation image that is different from the observation image in position on the observation target.

(6) The image processing apparatus according to any one of (1) to (5), in which

the visual field information generation unit is configured to acquire, when generating the visual field information, annotation information attached to an area corresponding to the visual field range of the specimen image.

(7) The image processing apparatus according to any one of (1) to (6), in which

the image acquisition unit is configured to acquire identification information of the observation target together with the input image, and

the visual field information generation unit is configured to identify an image area corresponding to the observation target in the specimen image based on the identification information and compare the image area with the input image.

(8) The image processing apparatus according to any one of (1) to (7), in which

the visual field information generation unit is configured to compare the specimen image with the input image, based on a plurality of scale invariant feature transform (SIFT) feature amounts extracted from the specimen image and a plurality of SIFT feature amounts extracted from the input image.

(9) An image processing method, including:

acquiring an input image having a first resolution, the input image being generated by capturing an observation image of an observation target;

comparing a specimen image with the input image, the specimen image including an image of the observation target and having a second resolution that is higher than the first resolution;

generating visual field information for identifying a visual field range corresponding to the input image in the specimen, based on a result of the comparison; and

acquiring information corresponding to the visual field range in the specimen image, based on the visual field information, and outputting a signal for displaying the information.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
an image acquisition unit configured to acquire an input image having a first resolution, the input image being generated by capturing an observation image of an observation target of a user;
a visual field information generation unit configured to compare a specimen image with the input image, the specimen image including an image of the observation target and having a second resolution that is higher than the first resolution, to generate visual field information for identifying a visual field range corresponding to the input image in the specimen image; and
a display controller configured to acquire information corresponding to the visual field range in the specimen image, based on the visual field information, and output a signal for displaying the information.

2. The image processing apparatus according to claim 1, wherein
the visual field information generation unit is configured to acquire information on a magnifying power of the observation image and compare the specimen image with the input image by using a ratio of a magnifying power of the specimen image to the magnifying power of the observation image.

3. The image processing apparatus according to claim 1, wherein
the visual field information generation unit is configured to instruct, when failing to generate the visual field information, a user to capture another observation image of the observation target.

4. The image processing apparatus according to claim 3, wherein
the visual field information generation unit is configured to
determine, when failing to generate the visual field information, whether the magnifying power of the observation image is a predetermined magnifying power or lower, and
instruct, when the magnifying power of the observation image is not the predetermined magnifying power or lower, the user to capture an observation image with the predetermined magnifying power or lower.

5. The image processing apparatus according to claim 3, wherein
the visual field information generation unit is configured to instruct, when failing to generate the visual field information, the user to capture another observation image that is different from the observation image in position on the observation target.

6. The image processing apparatus according to claim 1, wherein
the visual field information generation unit is configured to acquire, when generating the visual field information, annotation information attached to an area corresponding to the visual field range of the specimen image.

7. The image processing apparatus according to claim 1, wherein
the visual field information generation unit is configured to compare an area in the specimen image with the input image, the area corresponding to an image of an observation target identified by the visual field information already generated.

8. The image processing apparatus according to claim 1, wherein
the visual field information generation unit is configured to compare the specimen image with the input image, based on a plurality of scale invariant feature transform (SIFT) feature amounts extracted from the specimen image and a plurality of SIFT feature amounts extracted from the input image.

9. An image processing method, comprising:
acquiring an input image having a first resolution, the input image being generated by capturing an observation image of an observation target;
comparing a specimen image with the input image, the specimen image including an image of the observation target and having a second resolution that is higher than the first resolution;
generating visual field information for identifying a visual field range corresponding to the input image in the specimen, based on a result of the comparison; and
acquiring information corresponding to the visual field range in the specimen image, based on the visual field information, and outputting a signal for displaying the information.
